(19) United States
(12) Patent Application Publication
(10) Pub. No.: US 2001/0046062 A1
(43) Pub. Date: Nov. 29, 2001

(54) Serial printing method and serial printer

(75) Inventor: Takao Miyazaki, Saitama (JP)

Correspondence Address: SUGHRUE, MION, ZINN, MACPEAK & SEAS, 2100 Pennsylvania Avenue, N.W., Washington, DC, 20037, US

(73) Assignee: FUJI PHOTO FILM CO., LTD.

(21) Appl. No.: 09/855,943

(22) Filed: May 16, 2001

(30) Foreign Application Priority Data
May 17, 2000 (JP) 2000-144378

(51) Int. Cl. B41B 1/00

(52) U.S. Cl. 358/1.14

(57) ABSTRACT

A carriage is reciprocated in a width direction of a recording paper. A thermal head, a density sensor and an ink-ribbon cassette are attached to the carriage. While the carriage is moved forward, heat-transfer recording of one line is performed with the thermal head. While the carriage is moved backward after recording the line, the density sensor measures a density of each pixel of the line. The measured density is compared with a predicted density obtained from image data. When a difference between them exceeds a prescribed value, it is judged that a blur and uneven density occur on an image. At this time, the carriage is moved forward again to perform repair recording. When one of heating elements of the thermal head is detected as a broken element, recording is continued with the other normal heating elements.

### BACKGROUND OF THE INVENTION 1. Field of the Invention

The present invention relates to a serial printing method and a serial printer in which recording is performed with repair of defective print, and more particularly to a serial printing method and a serial printer in which white clarity is prevented from being caused by failure of a recording element.

2. Description of the Related Art

In a serial printer, a recording head is reciprocated in a width direction of a recording material to record one or more lines. Although it takes a time to print, it is possible to downsize the recording head. Owing to this, such a serial printer is widely used as a personal-use printer.

With respect to the serial printer, there are a thermal printer, an ink jet printer, a heat transfer printer, and so forth. In the thermal printer, a thermosensitive recording paper is heated by a thermal head for coloring. In the ink jet printer, an image is recorded by jetting an ink dot from an ink-jet head toward a recording paper (fine quality paper or the like). In the heat transfer printer, an image is recorded by heating an ink ribbon from its back side for transferring melted ink or sublimated ink to a recording paper. In other words, with respect to the heat transfer printer, there are a thermal-dye-transfer type and a thermal-wax-transfer type.

For instance, a serial printer performing heat-transfer recording of a melting type comprises a carriage and a conveyor. The carriage holds a thermal head to move it in a width direction of a recording paper. The conveyor moves the recording paper in a longitudinal direction thereof. An ink ribbon is heated by the thermal head to transfer melted ink to the recording paper, moving the thermal head in the width direction. After recording one or more lines, the conveyor advances the recording paper by one or more lines for preparation of the next recording. Upon repetition of this operation, an image is recorded on the recording paper.

Sometimes a blur (uneven density) and a density lack of the whole image occur on the printed image, although such phenomenons are not exclusive to the serial printer. Causes of these phenomenons are different in accordance with a type of the printer. For example, as to the thermal printer and the heat transfer printer, sometimes pressing force of the thermal head is momentarily changed due to influence of vibration and so forth, and sometimes a voltage applied to the head is temporarily changed. Upon such changes, the partial blur occurs on the printed image.

Moreover, with respect to the thermal printer, coloring properties of the thermosensitive recording paper vary in accordance with a change of humidity. Due to this, the lack of density occurs relative to the whole image. Further, the lack of density is sometimes caused by a change of the thermosensitive recording paper with the passage of time. Meanwhile, with respect to the heat transfer printer, transferring efficiency of the ink is different in accordance with the quality of the used recording paper. If the paper quality is bad, a lack of the image density occurs.

As to the ink jet printer, osmosis of ink varies in accordance with the quality of the recording paper so that a lack of image density sometimes occurs. Further, a blur sometimes occurs on an image due to a temporarily clogged nozzle and a temporary change of an amount of the jetted ink.

When the blur and/or the lack of density occur on the printed image, it is necessary to print the image again. In this case, consumption goods of the recording material, the ink, etc. are wasted and the time is also wasted.

In order to deal with the image blur and the lack of image density, a serial printer described in Japanese Patent Laid-Open Publication No. 6-328675, for example, is adapted to record a test pattern before recording an image. Density of this test pattern is measured. In case the blur and so forth occur, a driving condition of a recording head or a processing condition of the image is changed. After that, the image is recorded. Meanwhile, a heat-transfer serial printer described in Japanese Patent Laid-Open Publication No. 6-297823 is adapted to measure a density of each portion printed on a recording material by means of a sensor disposed near a recording head. When a blur occurs, it is informed to a user that an ink ribbon has outlived its usefulness. In other words, exchange timing of the ink ribbon is informed to the user.

However, even if the driving condition of the recording head and so forth are changed before recording the image, like the serial printer described in the above Publication No. 6-328675, partial lack of the image density (uneven density) is caused when surrounding conditions of humidity and so forth fluctuate during the sequential recording of the respective lines. Further, the partial lack of the image density is also caused when a voltage applied to the recording head fluctuates during sequential recording, and when a nozzle is clogged. Meanwhile, the serial printer described in the above Publication No. 6-297823 can not record an image immediately when an ink ribbon for exchange is not prepared. In this case, it is apprehensive to waste the time.

Further, when a heating element is broken in the thermal printer and the heat transfer printer, it is impossible to heat the thermosensitive recording paper and the ink ribbon. Thus, a row facing the broken heating element is kept in a white state. Also, when the nozzle of the ink jet printer is completely clogged, a row corresponding to this nozzle is similarly kept in a white state. Meanwhile, when a lack of density (uneven density) of an image occurs on a recording material which has been already discharged to the outside after recording the image, a method for repairing this image is not considered in the serial printer described in the above publication.

### SUMMARY OF THE INVENTION

In view of the foregoing, it is a primary object of the present invention to provide a serial printing method and a serial printer in which an image blur and a lack of image density are corrected during a recording operation.

It is a second object of the present invention to provide a serial printing method and a serial printer in which white clarity is prevented from occurring when a recording element, for instance a heating element and a nozzle, has broken.

In order to achieve the above and other objects, the serial printing method according to the present invention comprises a step of correction recording which is performed relative to a defective line.

The serial printer using the present printing method comprises a carriage and a recording head supported thereby. The carriage is reciprocated in a sub-scanning direction, or in a width direction of a recording material. The recording head records a predetermined number of rows on the recording material while the carriage is moved in a forward direction. While the carriage is moved in a backward direction, a density of the recorded portion is measured to be compared with a predicted density obtained from image data. When the measured density does not reach the predicted density, the carriage is moved again in the forward direction to perform correction recording. On the other hand, when the measured density reaches the predicted density, the recording material is advanced in a main-scanning direction for recording the next predetermined number of rows.

Although the density is measured during the backward movement of the carriage, the density may be measured during the forward movement of the carriage. In other words, the density may be measured just after recording when the carriage is moved in one direction.

In another serial printing method according to the present invention, a recording head in which recording elements are arranged in a main-scanning direction is moved in a sub-scanning direction. During this movement, a predetermined number of rows are recorded on a recording material. When one of the recording elements is detected as a broken element which is impossible to record due to its failure, the recording head is moved again to perform recording relative to the row to be recorded with the broken recording element. This recording is performed with another one of the normal recording elements.

Further, in another serial printing method according to the present invention, a recording material having been already recorded is set to a printer again. When it is judged that a print defect occurs on a certain line among the recorded lines, correction recording is performed for the defective line.

As stated above, in the present invention, the density of the recorded portion is measured to be compared with the predicted density. When the blur and the uneven density occur on the image, re-recording is performed so as to repair them. Thus, it is possible to record an image having a proper density. In addition, the recording material and the recording time may be prevented from being wasted.

In the serial printing method according to the present invention, the recording head is moved again when one of the recording elements is detected as the broken element. As for the row to be recorded with the broken recording element, recording is performed with another one of the normal recording elements so that a state of white clarity is prevented from occurring. From the next recording line, recording is performed by using the normal recording elements. Thus, printing can be continued even if one of the recording elements has broken.

In another serial printing method according to the present invention, the recording material already printed and discharged from the printer can be repaired so that it is possible to obtain an image having proper density.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a heat transfer serial printer according to the present invention;

FIG. 2 is a partially sectional view showing a head unit;

FIG. 3 is a plan view showing an ink ribbon;

FIG. 4 is a schematic illustration showing a density sensor;

FIG. 5 is a block diagram showing a control unit of the heat-transfer serial printer shown in FIG. 1;

FIG. 6 is an explanatory illustration showing an image recording state;

FIG. 7 is a flow chart showing a printing sequence of the heat-transfer serial printer shown in FIG. 1;

FIG. 8 is a partially sectional view showing the head unit in which the density sensors are provided at both sides of a thermal head;

FIG. 9 is a flow chart showing the printing sequence of an embodiment shown in FIG. 8;

FIG. 10 is a schematic illustration showing a thermal serial printer;

FIG. 11 is a schematic illustration showing an ink-jet serial printer;

FIGS. 12A and 12B are front views showing a recording paper used in a third embodiment according to the present invention;

FIG. 13 is a block diagram showing a control unit of the serial printer according to the third embodiment;

FIG. 14 is a flow chart showing the printing sequence of the embodiment shown in FIG. 13;

FIG. 15 is a succeeding flow chart under a condition that N equals two in the flow chart shown in FIG. 14;

FIG. 16 is a succeeding flow chart under a condition that N equals three in the flow chart shown in FIG. 14;

FIG. 17 is a succeeding flow chart under a condition that N equals four in the flow chart shown in FIG. 14;

FIG. 18 is a succeeding flow chart under a condition that N equals five in the flow chart shown in FIG. 14;

FIG. 19 is a succeeding flow chart under a condition that N equals six in the flow chart shown in FIG. 14;

FIG. 20 is an explanatory illustration showing a conveyance pattern of a recording paper and a drive pattern of the thermal head under a condition that a heating element of No. 1 has broken in the third embodiment;

FIG. 21 is an explanatory illustration showing the conveyance pattern of the recording paper and the drive pattern of the thermal head under a condition that the heating element of No. 2 has broken in the third embodiment;

FIG. 22 is an explanatory illustration showing the conveyance pattern of the recording paper and the drive pattern of the thermal head under a condition that the heating element of No. 3 has broken in the third embodiment;

FIG. 23 is an explanatory illustration showing the conveyance pattern of the recording paper and the drive pattern of the thermal head under a condition that the heating element of No. 4 has broken in the third embodiment;

FIG. 24 is an explanatory illustration showing the conveyance pattern of the recording paper and the drive pattern of the thermal head under a condition that the heating element of No. 5 has broken in the third embodiment;

FIG. 25 is an explanatory illustration showing the conveyance pattern of the recording paper and the drive pattern of the thermal head under a condition that the heating element of No. 6 has broken in the third embodiment;

FIG. 26 is a front view showing the recording paper used in another embodiment;

FIG. 27 is an explanatory illustration showing a state of a fourth embodiment in that the recording paper already recorded is set again;

FIG. 28 is a block diagram showing a control unit of the serial printer according to the fourth embodiment; and

FIG. 29 is a flow chart showing correction recording performed in the fourth embodiment.

### DETAILED DESCRIPTION OF THE PREFERRED EMBODIMENT(S)

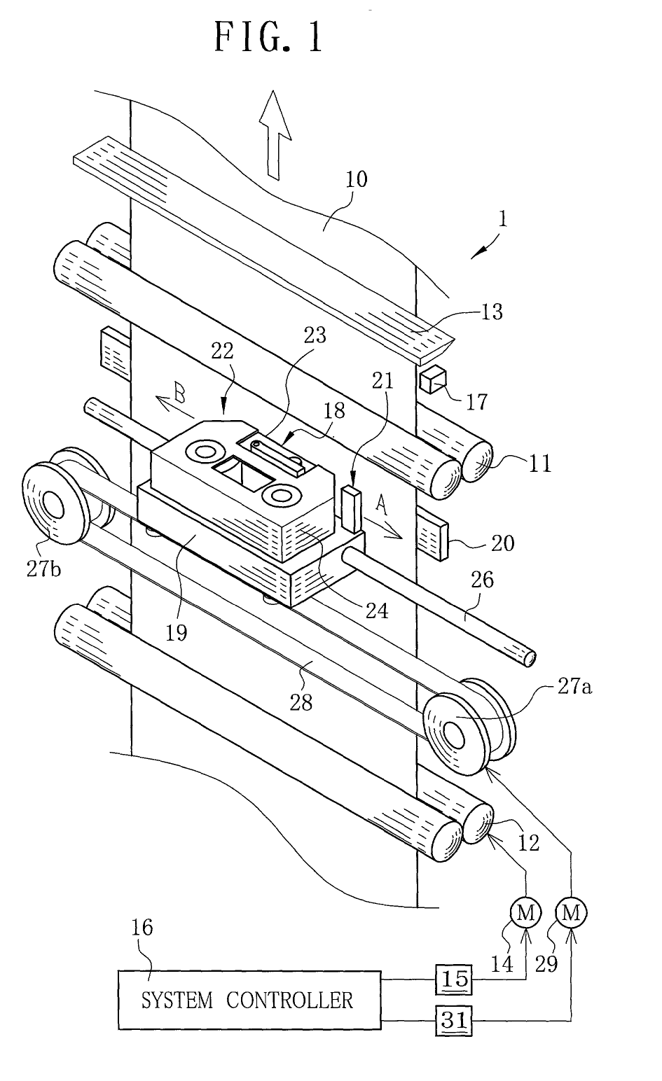

FIG. 1 shows a heat-transfer serial printer 1 according to the present invention. In this serial printer 1, a strip of a recording paper 10 is set to a paper feeder (not shown) in a state of a roll form. The recording paper 10 is drawn out of the paper feeder by a feeding roller pair 12 to pass through a conveying roller pair 11. An edge sensor 17 is disposed at a downstream side of the conveying roller pair 11. When the edge sensor 17 detects a leading edge of the recording paper 10, a detection signal is sent to a system controller 16. Upon receiving the detection signal, the system controller 16 shifts a pinch roller of the conveying roller pair 11 to nip the recording paper 10.

The feeding roller pair 12 and the conveying roller pair 11 are driven by a motor, for example by a pulse motor 14 which is controlled by the system controller 16 via a motor driver 15. During a printing operation, the conveying roller pair 11 is rotated in a forward direction to intermittently advance the recording paper 10 in a main-scanning direction shown by an arrow, every predetermined length. While the recording paper 10 is intermittently advanced, a head unit 22 is reciprocated in a sub-scanning direction to record three colors in a line sequential manner. A cutter 13 is disposed at a downstream side of the conveying roller pair 11 to cut off a printed region into a sheet. This sheet is discharged toward the outside by means of a discharging roller pair (not shown). Incidentally, instead of using the roll paper, a cut sheet having a predetermined size may be used.

The head unit 22 is constituted of a carriage 19, a thermal head 18 supported by the carriage 19, and a density sensor 21. A cassette 24 containing a sublimate-type ink ribbon 23 is mounted on the carriage 19 so as to be exchangeable. A guide rod 26 extending in the sub-scanning direction is inserted into the carriage 19. Moreover, a part of the carriage 19 is connected to a belt 28 put on a pair of pulleys 27a and 27b.

The pulleys 27a and 27b are driven by a motor, for example by a pulse motor 29. When the pulse motor 29 is rotated in a forward direction, the carriage 19 is moved in a direction shown by an arrow A, or is moved forward. When the pulse motor 29 is rotated in a backward direction, the carriage 19 is moved in a direction shown by an arrow B, or is moved backward. The pulse motor 29 is rotated upon receiving drive pulses and a signal representing a rotational direction (forward direction or backward direction) from a motor driver 31.

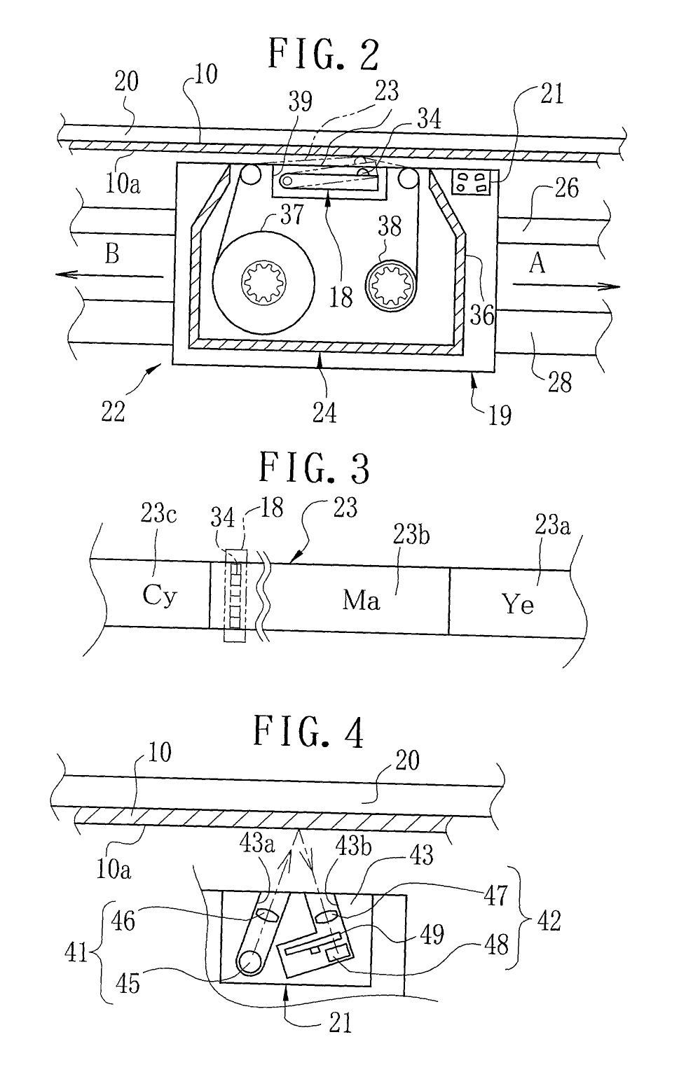

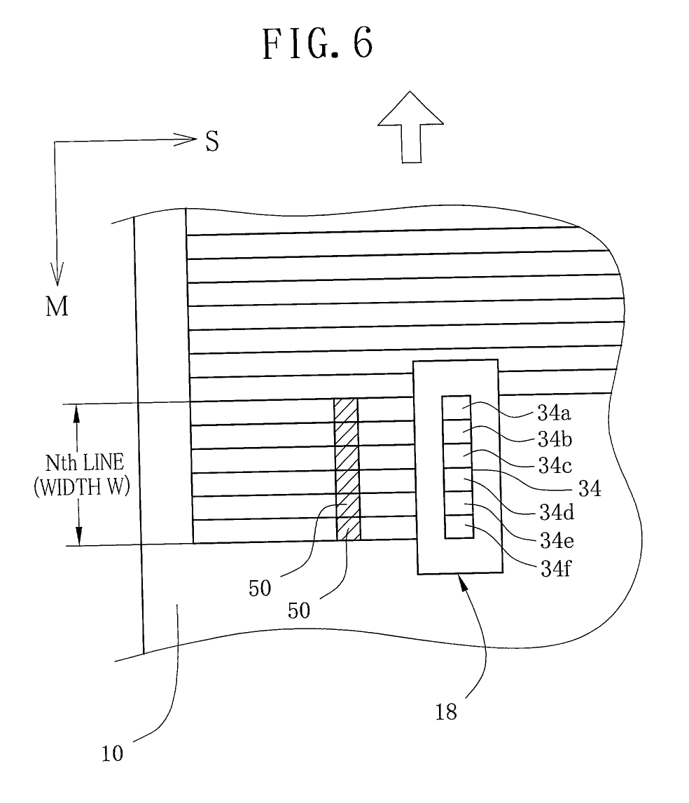

In FIG. 2, the thermal head 18 comprises a heating element array 34 in which a plurality of heating elements 34a to 34f are arranged in the main-scanning direction M such as shown in FIG. 6. The heating element array 34 is moved in the sub-scanning direction S to perform recording relative to an area of a width W. In this embodiment, a number of the heating elements 34a to 34f is six so that the width W corresponds to six rows. The thermal head 18 is swung between an evacuation position shown by a solid line in FIG. 2 and a print position shown by a two-dotted line therein. In the print position, the recording paper 10 is pressed by the heating element array 34 against a platen 20. In the evacuation position, the heating element array 34 is separated from the recording paper 10.

The cassette 24 rotatably contains a supply reel 37 and a take-up reel 38 in a cassette body 36. An unused ink ribbon is wound around the supply reel 37, and a used portion of the ink ribbon is wound up around the take-up reel 38. A front side of the cassette body 36 is formed with a cut portion 39 into which the thermal head 18 is inserted. In front of the cut portion 39, the ink ribbon 23 on which ink is applied is drawn out of the inside of the cassette body 36. The thermal head 18 put in the cut portion 39 heats the ink ribbon 23 from the back thereof to perform heat-transfer recording for the recording paper 10.

As shown in FIG. 3, the ink ribbon 23 includes a yellow ink area 23a, a magenta ink area 23b and a cyan ink area 23c which are repeatedly formed. Lengths of the respective areas 23a to 23c are identical with a width of the recording paper 10. In virtue of the three areas, a color image having a predetermined width is recorded. Incidentally, a black ink area may be added besides the three color areas. The above ink ribbon and the cassette for containing it are described in detail in Japanese Patent Laid-Open Publication No. 7-276761.

The density sensor 21 is disposed at one side of the carriage 19, and is constituted of a lighting device 41, a light receiving device 42, and a case 43 such as shown in FIG. 4. The lighting device 41 comprises a light source 45 and a condenser lens 46 for condensing the light from the light source 45 onto a surface 10a of the recording paper 10. The light receiving device 42 comprises a light receiving lens 47, a photo sensor 48, and a filter turret 49 for selecting one of wavelengths of red light, green light and blue light. As the photo sensor 48, a CCD image sensor is used. Six pixels 50 (see FIG. 6) simultaneously recorded with the heating elements 34a to 34f are individually measured by the density sensor 21. The case 43 holds the lighting device 41 and the light receiving device 42. The front of the case 43 is formed with openings 43a and 43b so as to bare the light source 45 and the photo sensor 48 via the condenser lens 46 and the light receiving lens 47 respectively.

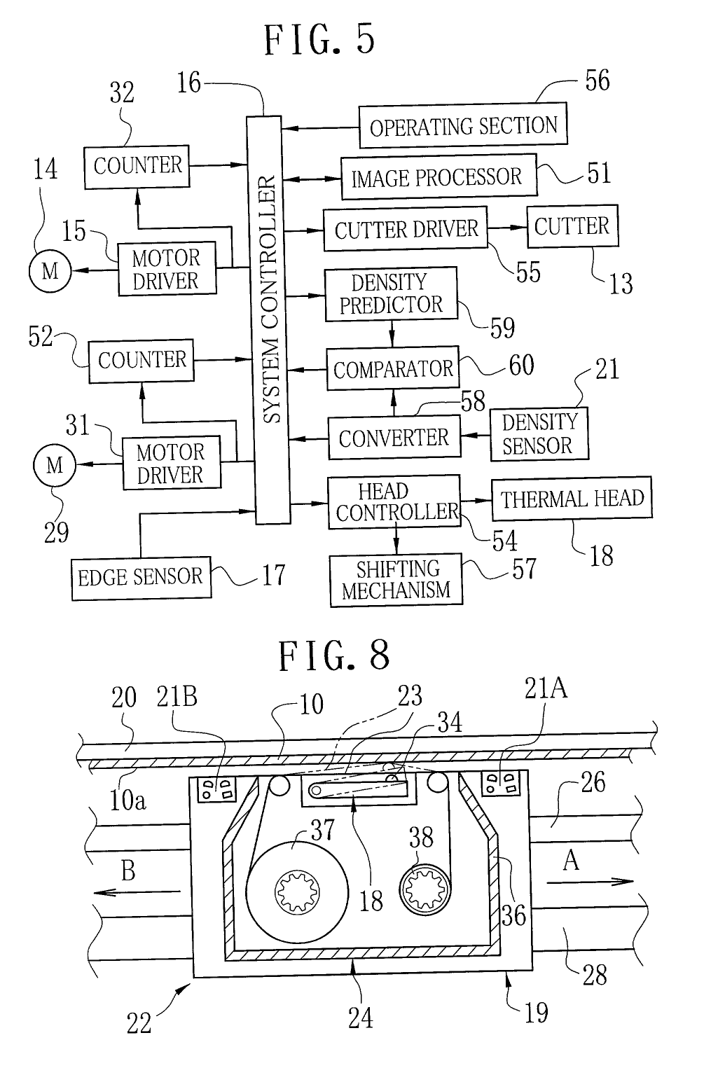

As shown in FIG. 5, the system controller 16 is connected to an image processor 51, the motor driver 15, the motor driver 31, a counter 32, a counter 52, a head controller 54, and a cutter driver 55. Printing is instructed with an operating section 56. The image processor 51 converts image data of blue, green and red into image data of yellow, magenta and cyan to write it in an image memory. Incidentally, the image data of blue, green and red are inputted by a scanner, an electronic still camera, and so forth. When the image data is read from the image memory, gradation conversion is performed in accordance with recording properties of the printer before being sent to both of the head controller 54 and a density predictor 59.

The system controller 16 activates the counter 32 for counting the drive pulse to measure an advancing amount of the recording paper 10 when the edge sensor 17 detects the leading edge of the recording paper 10. A print size of the recording paper 10 is predetermined. A record starting position and a recording finish position of the recording paper are also predetermined, and these positions are controlled based on a count value of the counter 32. While printing is carried out, the pulse motor 14 is intermittently driven. Whenever the heat-transfer record corresponding to the six rows is completed, the recording paper 10 is advanced by the predetermined width W.

Meanwhile, the system controller 16 rotates the pulse motor 29. At the same time, the system controller 16 activates the counter 52 to measure a moving amount of the carriage 19 on the basis of a count value of the drive pulses. Based on the count value of the counter 52, the head controller 54 is controlled.

The head controller 54 controls heating amounts of the respective heating elements 34a through 34f of the thermal head 18 on the basis of the image data outputted from the image processor 51. At the same time, the head controller 54 drives a shifting mechanism 57 which shifts the thermal head 18 to press the ink ribbon 23 against the recording paper 10.

A signal is outputted from the photo sensor 48 of the density sensor 21. With respect to this signal, logarithmic conversion and complementary-color conversion are carried out in a converter 58 so as to be converted to quasi-densities of yellow, magenta and cyan. Pixel data of yellow, magenta and cyan of the image to be printed are converted, by the density predictor 59, into dot densities of the recording paper 10. This density conversion may be performed by using a conversion table showing a relationship between the image signal and the density.

The densities from the converter 58 and the density predictor 59 are sent to a comparator 60 respectively as the measured density and the predicted density to be compared with each other every color and every pixel. When a value of the measured density is smaller than that of the predicted density, its density difference is calculated to be sent to the system controller 16. In a case there is the density difference, a blur of the image and uneven density occur. The system controller 16 draws up corrected print data so as to make the density difference “zero”. The print data is sent to the head controller 54 to perform repair recording.

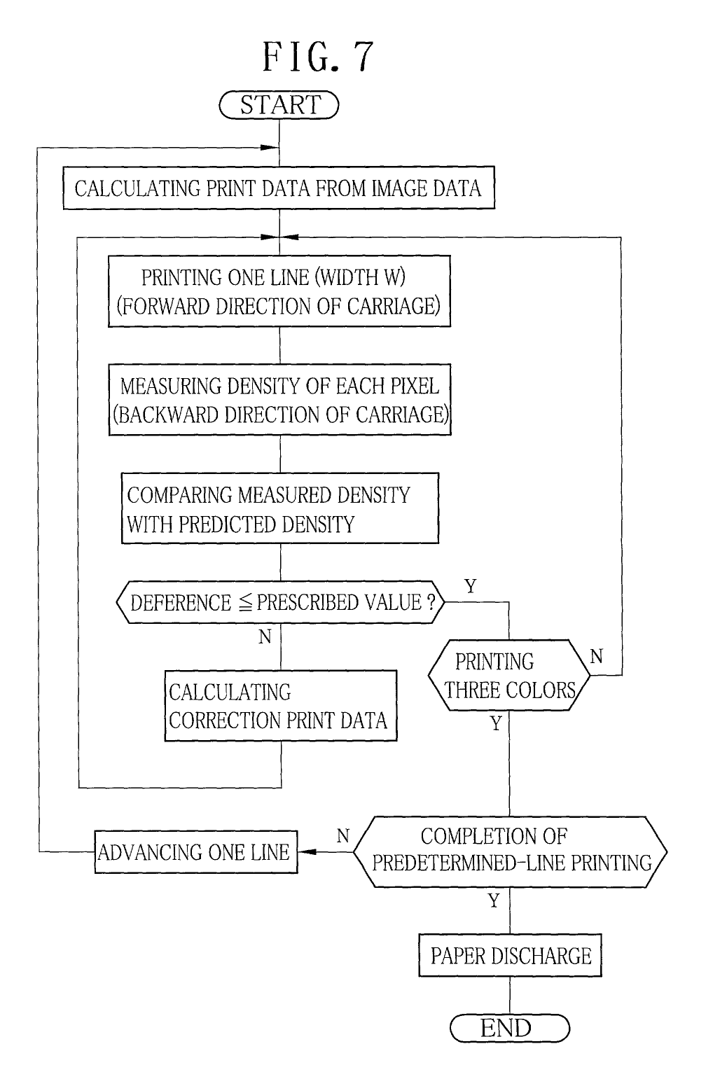

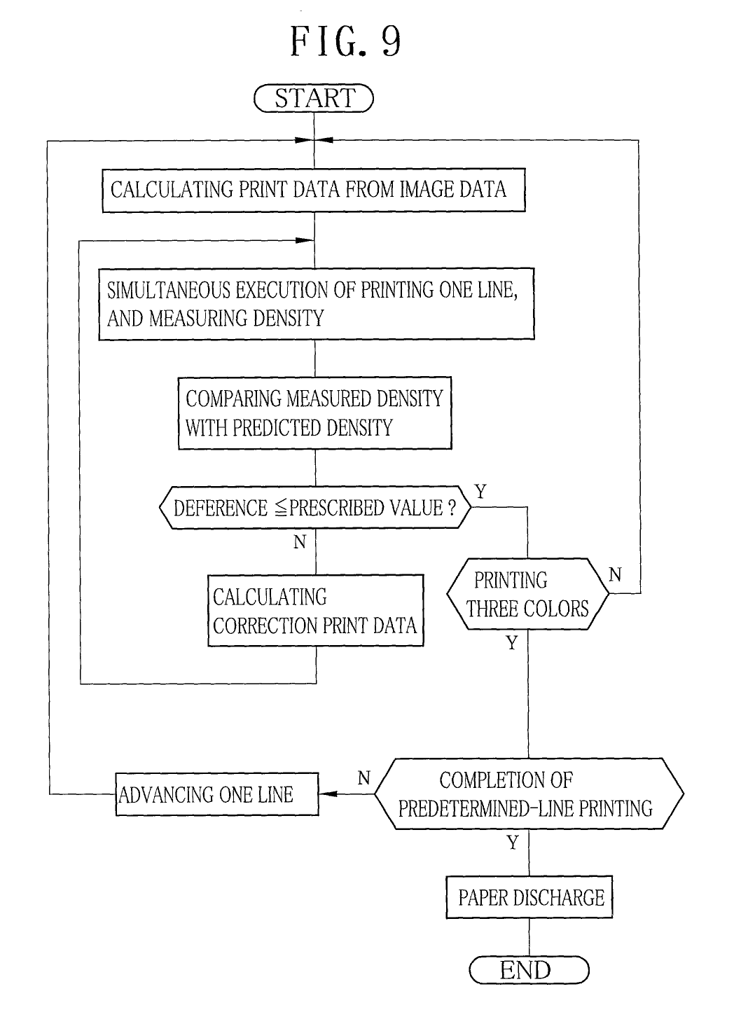

Next, an operation of the present embodiment is described below, referring to a flow chart shown in FIG. 7. When printing is instructed from the operating section 56, the system controller 16 reads the one-frame image data from the image processor 51 to convert the image data of blue, green and red into the images of yellow, magenta and cyan. The image data of three colors are sent to the density predictor 59 to calculate the predicted density of each color relative to the respective pixels. After calculating the predicted density, the recording paper 10 is fed, and at the same time, the pulse motor 14 starts to rotate in the forward direction. The recording paper 10 is advanced from the paper feeder and is nipped with the feeding roller pair 12 to be moved toward the conveying roller pair 11. When the leading edge of the recording paper 10 is detected by the edge sensor 17, one of the conveying roller pair 11 is shifted to nip the recording paper 10.

After nipping the recording paper 10 with the conveying roller pair 11, the counter 52 is activated. When the conveying roller pair 11 is slightly rotated and the record starting position faces the thermal head 18, recording the yellow image is started. At this time, the top end of the yellow ink area 23a of the ink ribbon 23 is located at the position of the thermal head 18. The head controller 54 moves the thermal head 18 to the print position first. And then, the one-line image data of the yellow image is read from the image processor 51 to be sent to the thermal head 18. Successively, the system controller 16 rotates the pulse motor 29 in the forward direction to move the head unit 22 forward. In synchronism with the forward movement of the head unit 22, the thermal head 18 is driven based on the image data of six rows. At the same time, the reels 37 and 38 of the cassette 24 are rotated. Thus, each of the heating elements 34a to 34f is heated up to a temperature corresponding to the density to be recorded, and the first line of the yellow image is recorded on the recording paper 10 in the width W. Incidentally, FIG. 6 shows a state in that the Nth line is recorded.

When the yellow image of six rows has been recorded in the heat-transfer manner and the head unit 22 has come to the end of its stroke, the system controller 16 stops the forward movement of the head unit 22 and sets the thermal head 18 to the evacuation position. Successively, the density sensor 21 is activated and the light source 45 is turned on. At the same time, the filter turret 49 is rotated to set a blue filter. The pulse motor 29 is rotated in the backward direction to move the head unit 22 backward. In synchronism with this backward movement, is illuminated the yellow image of six rows recorded during the forward movement of the head unit 22. The photo sensor 48 measures an amount of the reflected light. In virtue of this, the reflected light of each of six pixels 50, which are simultaneously recorded as shown in FIG. 6, is individually measured.

The signals of six pixels outputted from the photo sensor 48 are respectively converted into the measured densities of yellow at the converter 58. The measured densities of six pixels are sent to the comparator 60 in which the predicted densities of the corresponding six pixels are inputted from the density predictor 59. In the comparator 60, the density difference is calculated every pixel. When the difference between the measured density and the predicted density is a prescribed value or less, the system controller 16 judges that the density belongs to a proper range. In this case, recording the yellow image is finished, and then, one line of the magenta image is started to be recorded.

When the measured density is smaller than the predicted density and when the difference between them exceeds the prescribed value, the system controller 16 judges a lack of density and draws up yellow-correction print date every pixel to record the yellow image again. This print data is for correcting the lack of density. In this case, the used yellow ink area 23a is rewound so as to confront the leading portion thereof with the thermal head 18. Incidentally, the reels 37 and 38 may be rotated until a leading portion of the next yellow ink area 23a. The system controller 16 sets the thermal head 18 to the print position and moves the head unit 22 in the forward direction again. In synchronism with the forward movement of the head unit 22, the thermal head 18 is driven based on the correction print data. Owing to this, the respective heating elements 34a to 34f are heated in accordance with the lack of density to record the one-line yellow image on the recording paper 10 again. Successively, in synchronism with the backward movement of the head unit 22, the densities of the yellow image corresponding to the six rows are measured again. In this way, correction recording and the measurement of density are performed and are repeated until the difference between the measured density and the predicted density becomes the prescribed value or less.

When one-line recording of the yellow image has been completed in the heat-transfer manner, the take-up reel 38 of the cassette 24 is rotated to wind the ink ribbon 23, and a reading portion of the magenta ink area 23b is adjusted to the position of the thermal head 18. Similarly to the above, the head unit 22 is moved in the forward direction after shifting the thermal head 18 to the print position. During the forward movement of the head unit 22, the heating element array 34 is driven based on the magenta image data to record the first line of the magenta image on the recording paper 10. Hence, six dots of magenta aligned in the main-scanning direction overlap with the six dots of yellow already recorded.

After recording the first line of the magenta image, the head unit 22 is moved in the backward direction. During this backward movement, the densities of the first line constituted of six rows are measured. When the image blur occurs, the head unit 22 is reciprocated again to perform repair recording relative to the first line. Similarly, one line of the cyan image is recorded in the heat-transfer manner. In this case, the yellow ink absorbs both of magenta ingredients and cyan ingredients, and the magenta ink absorbs the cyan ingredients so that the predicted density is calculated in consideration of the secondarily absorbed ingredients.

After one line of the image has been recorded in the three-color line sequence, the system controller 16 rotates the pulse motor 14 to advance the recording paper 10 by one line (width W). Successively, the next line is recorded such as described above. As a result, the whole image is recorded on the recording paper 10. The record is performed every color in each line such that the difference between the measured density and the predicted density becomes the prescribed value or less. Thus, even if the blur and the uneven density occur in the image formed on the recording paper 10, it is possible to repair them.

After recording the image, the conveying roller pair 11 is slightly rotated to set the end of the record area at the position of the cutter 13. The system controller 16 actuates the cutter 13 via the cutter driver 55 to cut the recording paper 10 into a sheet for discharging it toward the outside of the printer 1.

Upon instruction of the next printing, the counters 32 and 52 are reset and the following image is printed on the recording paper 10 similarly to the above. Meanwhile, when a switch of a power supply is turned off, the pulse motor 14 is rotated in the backward direction to rewind the recording paper 10 into the paper feeder.

Although the plural rows are recorded with the plural heating elements, the thermal head 18 may be provided with a single heating element to record every row. In this case, the density sensor 21 measures the respective dots of the row in order.

Under a condition that there is no trouble with the heating elements, the densities of the dots simultaneously recorded are likely to fluctuate in a similar way. In view of this, the densities of six dots may be averaged to find a mean of the measured densities, and by which common print data for correction may be drawn up.

Next, a second embodiment according to the present invention is described below. In this embodiment, recording the image and measuring the density are simultaneously performed. Such as shown in FIG. 8, density sensors 21A and 21B are disposed at both sides of the thermal head 18 relative to the sub-scanning direction. Incidentally, a member being identical with that in FIG. 2 is denoted by the same reference numeral, and explanation thereof is omitted.

When the head unit 22 is moved in a direction shown by an arrow A, a predetermined number of rows are recorded relative to yellow, for example. During this record, the density sensor 21B measures the yellow dot just after recording thereof. In virtue of the density sensor 21B, are obtained the measured densities which are compared with the predicted densities to draw up the print data for correction.

When the head unit 22 is moved in a direction shown by an arrow B, the thermal head 18 is driven based on the print data for correction to perform the repair recording. During this repair recording, the densities are measured by the density sensor 21A to be compared with the predicted densities again. When the repair recording is almost perfect and the respective pixels have been substantially recorded in the predicted densities, the next recording for magenta is performed.

In case the repair recording is imperfect, the second repair recording is performed while the head unit 22 is moved in the direction shown by the arrow A. When the second repair recording is perfect, recording the magenta is performed while the head unit 22 is moved in the direction shown by the arrow B. Although the recording directions of the primary recording and the repair recording are not fixed, the recording and the density measurement are simultaneously performed so that it is possible to print at high speed.

In the first and second embodiments, the color printer using the yellow ink, the cyan ink and the magenta ink is described as an example of the heat-transfer serial printer. The present invention, however, is not exclusive to this. For instance, the present invention may be applicable to a monochrome printer using only a black ink. Moreover, the heat-transfer system is not exclusive to the sublimate type, or the thermal-dye-transfer type. The thermal-wax-transfer type may be adopted.

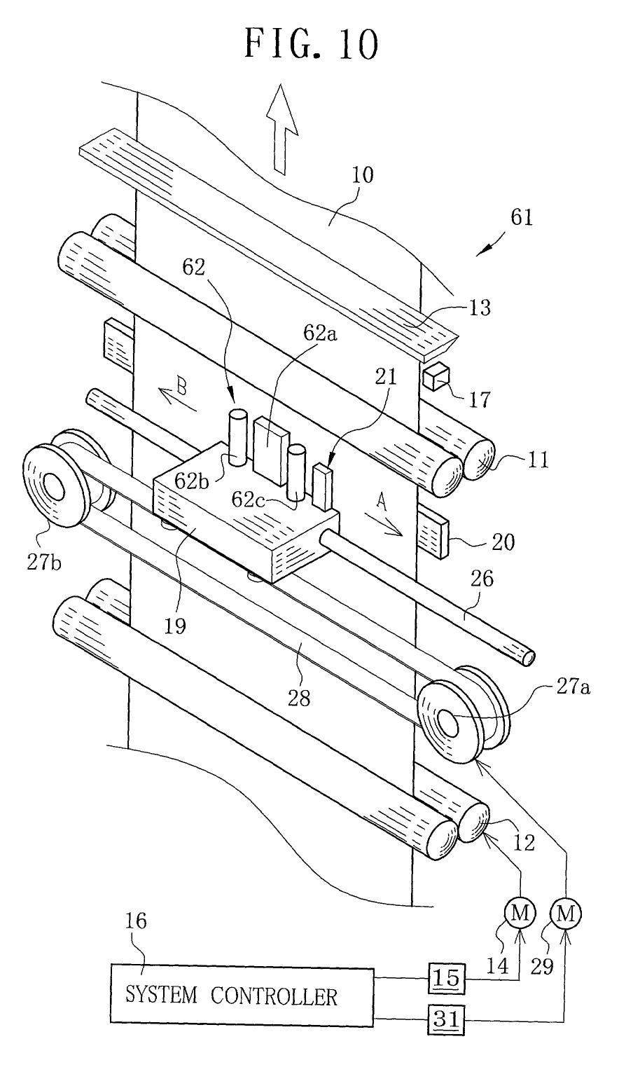

In the first and second embodiments, is described the heat-transfer serial printer in which the thermal head is mounted on the carriage. However, the present invention is not exclusive to the heat-transfer serial printer and may be applicable to a thermal serial printer in which a thermal head is mounted on a carriage such as shown in FIG. 10. In this thermal serial printer 61, a head unit 62 is constituted of a thermal head 62a, light sources 62b and 62c used for optical fixation, the density sensor 21, and the carriage 19 for carrying them. Such a serial printer is described in detail in Japanese Patent Laid-Open Publication No. 5-124352, for example. By the way, as to the recording paper 10, is employed a thermosensitive recording paper in which thermosensitive coloring layers of yellow, cyan and magenta are stacked on a base.

In this embodiment, first of all, the thermal head 62a is driven based on an image signal corresponding to one line, in synchronism with the forward movement of the head unit 62. Owing to this, the first line of the yellow image is colored to be recorded on the recording paper 10. Successively, in synchronism with the backward movement of the head unit 62, is measured the density of the one-line yellow image recorded during the forward movement of the head unit 62. When the difference between the measured density and the predicted density is a prescribed value or less such as described above, the head unit 62 is moved in the forward direction again. At the same time, the light source 62b for fixing yellow is turned on to optically fix the yellow image.

In case the image blur occurs, the head unit 62 is moved in the forward direction to perform the repair recording with the thermal head 62a. During the succeeding backward movement of the head unit 62, the density is measured. When the repair recording is perfect, the head unit 62 is moved in the forward direction to perform the fixation of the yellow image. Successively, the head unit 62 is moved in the backward direction as it is, and then, one line of the magenta image is recorded.

Similarly, with regard to the recording of the magenta image, the light source 62c for fixing magenta is turned on to optically fix the magenta image when the difference between the measured density and the predicted density is a prescribed value of less. When the difference is greater than the prescribed value, the repair recording of magenta is performed. Recording the cyan image is similarly performed. Incidentally, as for the cyan thermosensitive coloring layer, optical fixation properties are not given thereto.

As an example of the thermal serial printer, is described the color printer using the thermosensitive recording paper in which the thermosensitive coloring layers of yellow, cyan and magenta are stacked. However, this is not exclusive. It is possible to adopt a monochrome printer using a thermosensitive recording paper coloring only in black.

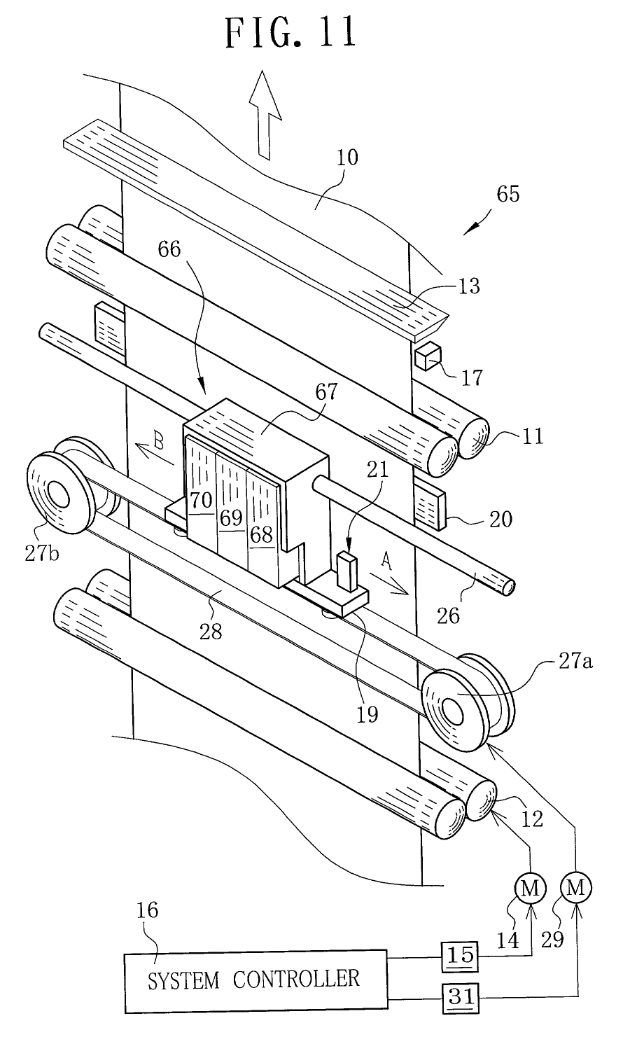

All of the above embodiments use the thermal serial printer. However, it is possible to use an ink-jet serial printer in which an ink-jet head is mounted on a carriage such as shown in FIG. 11. In this ink-jet serial printer 65, a head unit 66 is constituted of an ink-jet head 67 for recording with jetted ink, the density sensor 21, and the carriage 19 for carrying them. The ink-jet head 67 includes ink tanks 68, 69 and 70 respectively containing yellow ink, magenta ink and cyan ink. Further, the recording head 67 includes three kinds of ink nozzle groups (not shown) connected to the ink tanks 68, 69 and 70 respectively. Each of the ink nozzle groups comprises a plurality of ink nozzles arranged in the main-scanning direction to simultaneously record a plurality of rows. The density sensor 21 measures ink dots of the plural rows.

In the above embodiments, when one line is recorded in the three-color line sequence of yellow, magenta and cyan, the density is measured every time after recording each color. However, the density may be measured when the one-line recording of three colors has been over. And then, the measured density may be compared with the predicted density to perform the repair recording.

In the first and second embodiments, the density of each portion printed on the recording material is measured. When the measured density does not reach the predicted density, the recording head is driven for the portion having the density difference, and the correction recording is performed in accordance with the density difference. Owing to this, the image blur and the uneven density occurring on the recording material are repaired. Such a method and the serial printer adopting this method are described in the first and second embodiments. The present invention, however, is not exclusive to this. Hereinafter, a third embodiment according to the present invention is described. The third embodiment relates to a method and a serial printer adopting this method in which white clarity is prevented from occurring when an image is recorded by the serial printer. The white clarity is a print defect more serious rather than the blur and the uneven density. Incidentally, regarding a member which is identical with that of the first and second embodiments, the same reference numeral is used and a detailed explanation thereof is omitted.

The heat-transfer serial printer according to this embodiment is shown in FIGS. 1 and 2, and the ink ribbon 23 used therein is shown in FIG. 3. As to the density sensor 21 attached to the carriage 19 of the heat-transfer serial printer 1, the sensor shown in FIG. 4 is used. The density measured by the sensor 21, however, is not used for correcting the blur and the uneven density as described in the first and second embodiments. The measured density is used for judging whether any of the heating elements 34a through 34f (see FIG. 6) incorporated in the thermal head 18 has broken or not. By the way, in this embodiment, the heating elements 34a to 34f are numbered from 1 to 6 in numeric order, for convenience of explanation.

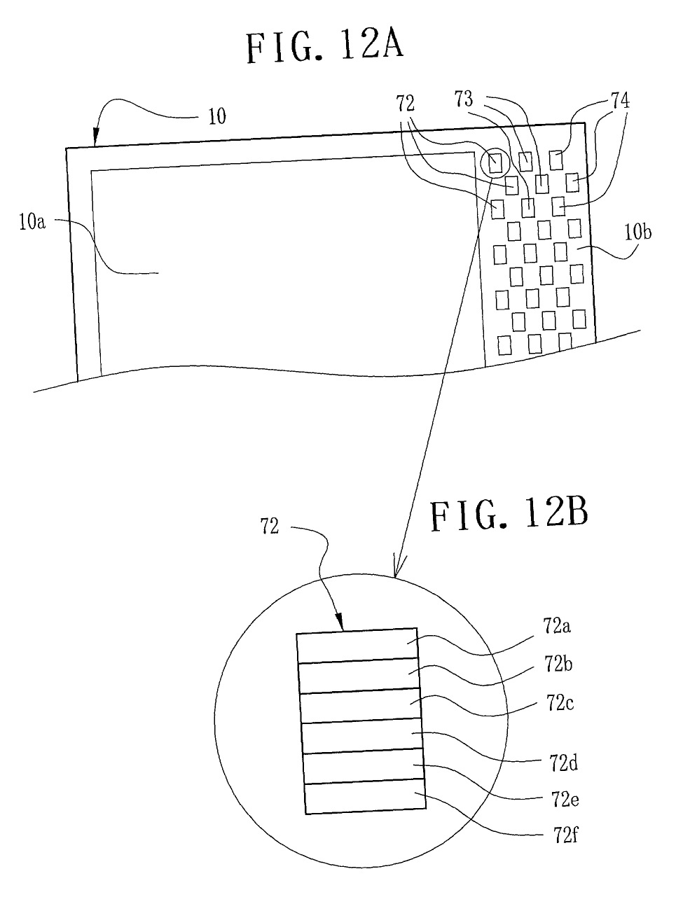

As shown in FIG. 12A, the recording paper 10 used in the heat-transfer serial printer of this embodiment is formed with an image area 10a and a test-pattern area 10b located at a side of the image area 10a. The test-pattern area 10b is for forming a test pattern. Based on the image data, the image is recorded on the image area 10a similarly to the first and second embodiments. Meanwhile, test patterns 72, 73, 74 of cyan, magenta and yellow are recorded on the test-pattern area 10b after recording the image of six rows on the image area 10a. Positions of the test patterns 72, 73 and 74 exist on an extended line of six rows recorded on the image area 10a.

FIG. 12B shows the enlarged test pattern 72 of cyan. Test pattern rows 72a to 72f are respectively recorded in fixed density by means of the heating elements 34a to 34f. With respect to the test patterns 73, 74 of magenta and yellow, the heating elements 34a to 34f are similarly heated to record the test pattern rows corresponding thereto.

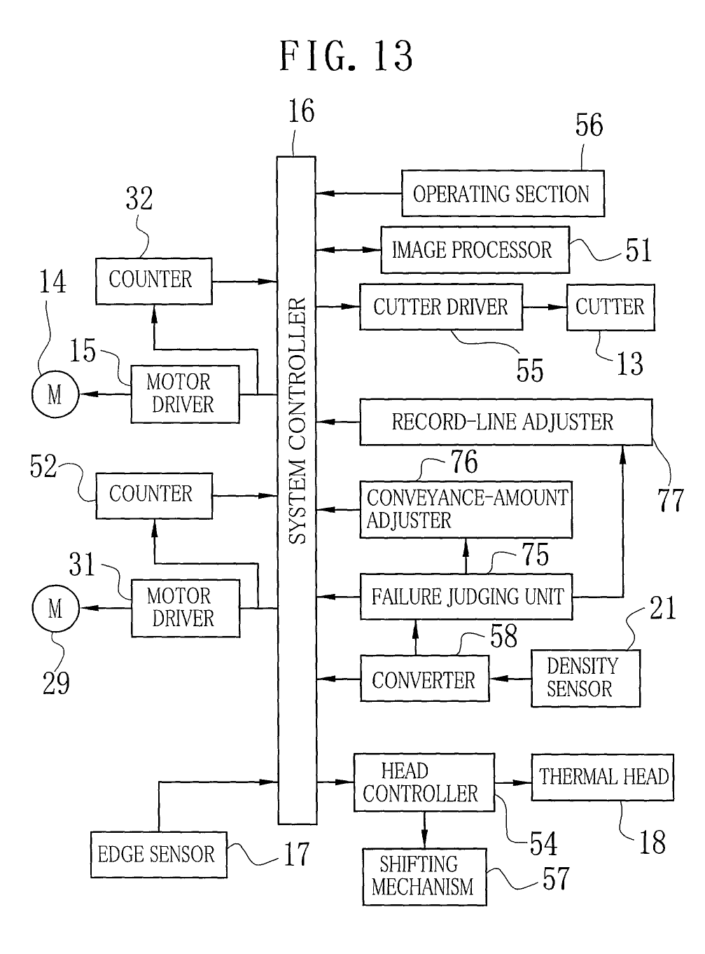

FIG. 13 is a block diagram showing an electrical structure of the heat-transfer serial printer according to this embodiment. The system controller 16 is connected to a failure judging unit 75, a conveyance-amount adjuster 76, and a row adjuster 77 in addition to the ones described in the first embodiment. A signal outputted from the photo sensor 48 of the density sensor 21 is converted into quasi-densities of yellow, magenta and cyan after the logarithmic conversion and the complementary-color conversion have been carried out in the converter 58.

The density from the converter 58 is sent to the failure judging unit 75 as the measured density. In the failure judging unit 75, a preset minimum density is read to be compared with the measured density every color and every pixel. When the measured density does not reach the minimum density, it is judged that the heating element having recorded the corresponding pixel is broken. The minimum density is determined, taking account of a condition that it is impossible to record the image due to failure of the heating elements 34a to 34f, for example, due to wire breaking and rupture thereof. Moreover, the minimum density is set to a fixed value in consideration of characteristics concerning the thermal head 18, the recording paper 10, and so forth. The failure judging unit 75 sends the number (one of Nos. 1 to 6) of the heating element, which is judged as a broken element, to both of the conveyance-amount adjuster 76 and the row adjuster 77.

In the conveyance-amount adjuster 76, patterns for moving the recording paper 10 are stored in accordance with the number of the broken heating element so as to be recordable only with the normal heating elements. When the number of the broken heating element is sent from the failure judging unit 75 to the conveyance-amount adjuster 76, the corresponding conveyance pattern is read to be sent to the system controller 16. The system controller 16 changes a rotational amount of the conveying roller pair 11 according to the conveyance pattern sent from the conveyance-amount adjuster 76. Moreover, the system controller 16 controls the pulse motor 14 via the motor driver 15 so as to change the rotational direction thereof from the forward direction to the backward direction or from the backward direction to the forward direction.

In the row adjuster 77, drive patterns for controlling the thermal head 18 are stored. Owing to this, recording is performed with the whole or a part of the remaining heating elements, which are normal, in accordance with the number of the broken heating element. At this time, the heating element which are not used for recording is not activated. When the number of the broken heating element is sent from the failure judging unit 75, the drive pattern corresponding to this number is read to be sent to the system controller 16. The system controller 16 controls the thermal head 18 via the head controller 54 so as to perform the recording based on the drive pattern sent from the row adjuster 77.

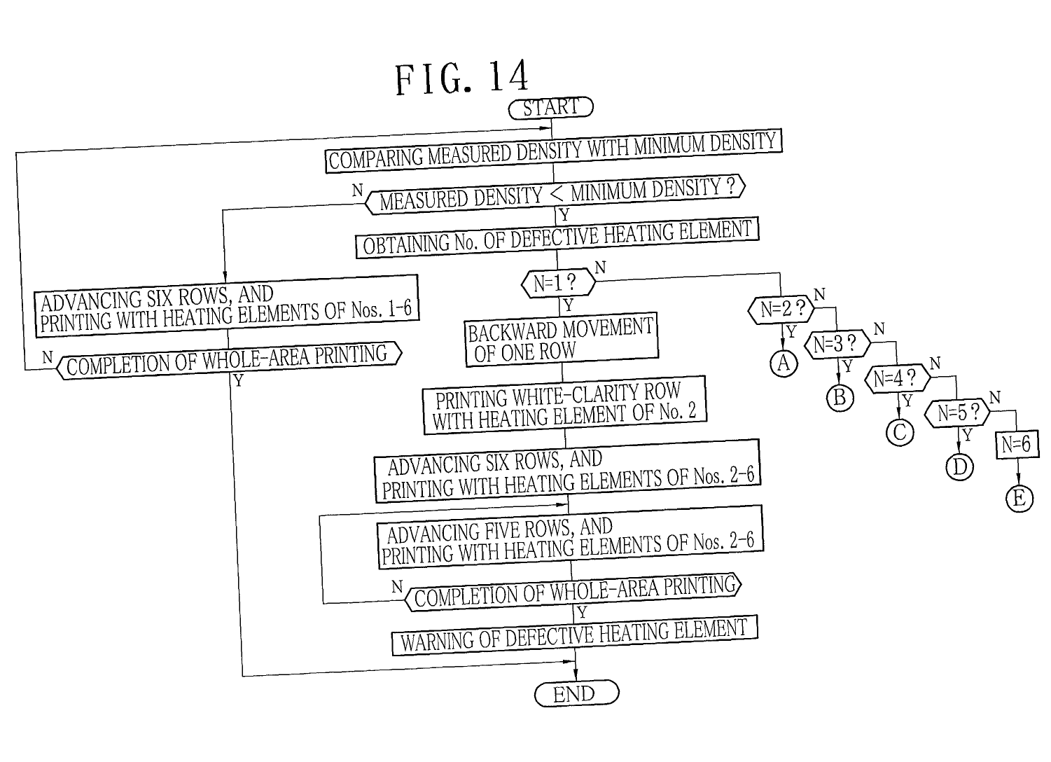

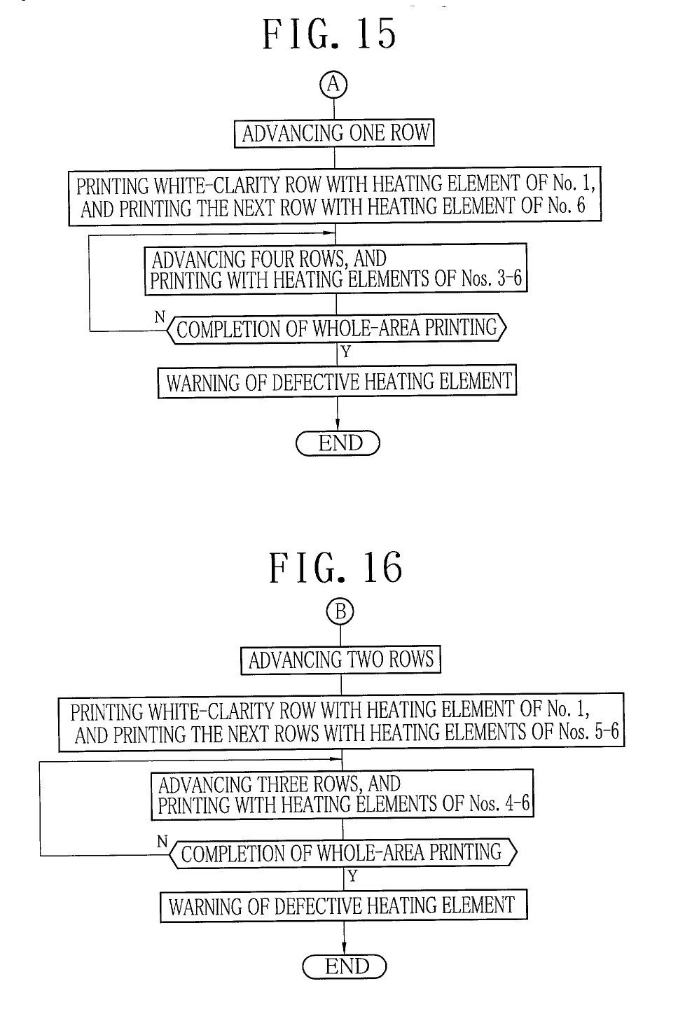

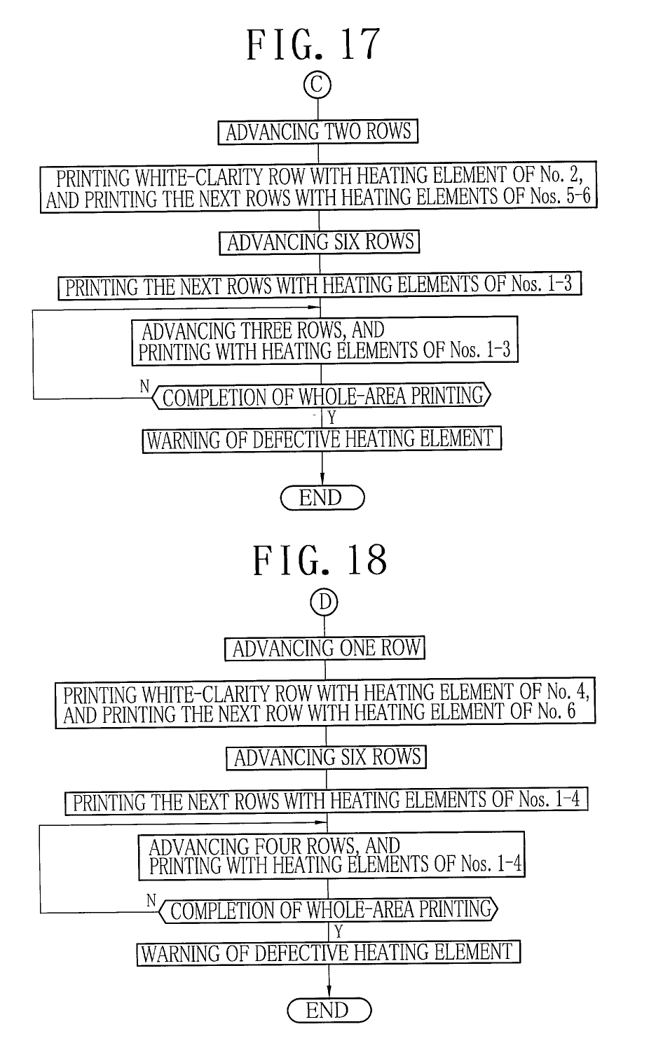

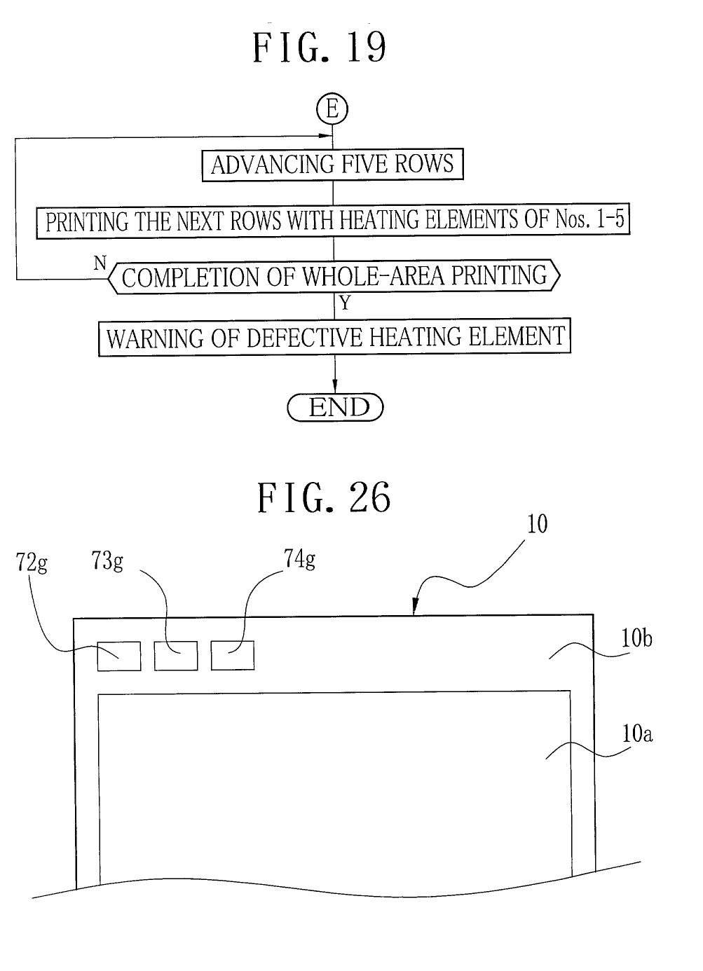

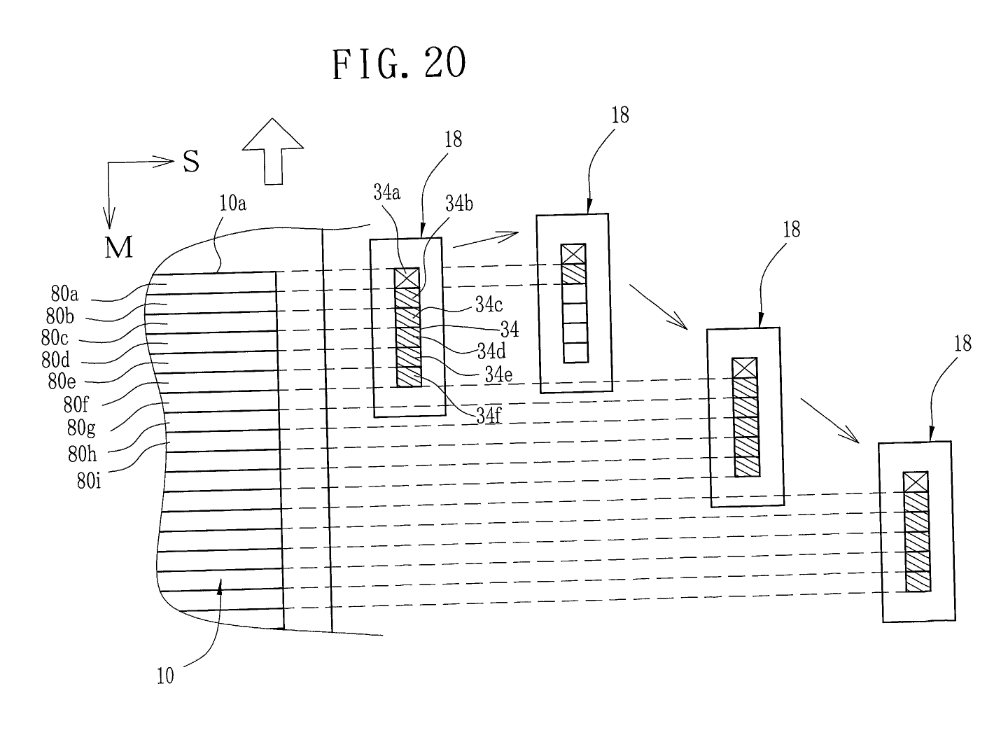

Next, an operation of this embodiment is described below, referring to flow charts shown in FIGS. 14 through 19 and to explanatory illustrations shown in FIGS. 20 through 25. FIGS. 20 through 25 schematically show the conveyance pattern of the recording paper 10 and the drive pattern of the thermal head 18 which are stored in the conveyance-amount adjuster 76 and the row adjuster 77 respectively. In order to make the drawings comprehensible, the position of the thermal head 18 is shifted in FIGS. 20 through 25 to show the conveyance amount of the recording paper 10. For instance, when the recording paper 10 is advanced in the main-scanning direction by one row, the position of the thermal head 18 is adapted to be shown such that the thermal head 18 is reversed in the main-scanning direction by one row.

When the printing is instructed from the operating section 56, the system controller 16 reciprocates the thermal head 18 by three times to record six rows in the three-color line sequential manner on the image area 10a shown in FIG. 12. At the same time, the test patterns 72, 73, 74 of cyan, magenta and yellow are recorded on the test-pattern area 10b.

Successively, the density sensor 21 is driven to measure the densities of the respective test patterns 72, 73 and 74 already recorded. The measured densities are converted into the signals via the converter 58 every color and every row to be sent to the failure judging unit 75 in which the measured density is compared with the minimum density. In case the measured density of the row does not reach the minimum density, the heating element (one of the elements 34a to 34f) having recorded this row is judged as the broken element. Then, the corresponding number (one of Nos. 1 to 6) is sent to both of the conveyance-amount adjuster 76 and the row adjuster 77. Meanwhile, when all of the measured densities exceed the minimum density, it is judged that the heating elements 34a to 34f are not broken. In this case, when the printing is performed for the next six rows, the conveyance pattern of the recording paper 10 and the drive pattern of the thermal head 18 are normal. In other words, the advancement of six rows and the recording thereof are normally repeated to record the image on the recording paper 10.

When the number of the broken heating element is sent to both of the conveyance-amount adjuster 76 and the row adjuster 77, the conveyance pattern of the recording paper 10 and the drive pattern of the thermal head 18 are read in accordance with this number to be sent to the system controller 16. The system controller 16 controls the pulse motor 14 and the thermal head 18 on the basis of the conveyance pattern and the drive pattern having been read.

Hereinafter, are described the conveyance pattern and the drive pattern of the case in that one of the heating elements represented by Nos. 1 to 6 is the broken element. These patterns are described concerning the respective numbers. As shown in FIG. 20, when the heating element 34a represented by No. 1 is the broken element, a row 80a to be recorded by the heating element 34a becomes a white state (hereinafter, such a row is called as white-clarity row). Incidentally, the row 80a is the first row of the initial six rows 80a to 80f recorded on the image area 10a. In this case, the pulse motor 14 is reversed to move the recording paper 10 in the backward direction by one row. Owing to this, the heating element 34b represented by No. 2 is adjusted to the position of the white-clarity row 80a. And then, the thermal head 18 is controlled to heat the heating element 34b so that the image is recorded on the white-clarity row 80a.

Upon the recording of the white-clarity row 80a, the recording of the first line corresponding to the six rows is over. After that, in order to perform the recording of the seventh row 80g and succeeding rows thereof, the pulse motor 14 is rotated forward to move the six rows in the forward direction. From the second line of the image, the heating element 34a of No. 1 is not activated, and the heating elements 34b to 34f of Nos. 2 to 6 are heated to record the image on the recording paper 10. From the third line of the image, the advancement of five rows and the recording thereof with the heating elements 34b to 34f are repeated to record the image on the whole of the image area 10a. After recording the image, the failure of the heating element is indicated toward the outside to call user's attention to exchange of the component of the thermal head. Also, in case one of the heating elements represented by Nos. 2 to 6 is the broken element as described later, the failure of the heating element is similarly indicated to the outside after the image has been recorded.

While one line is constituted of five rows from the third line, the test printing is similarly performed on the test-pattern area 10b and its density is measured. When one of the other heating elements has further broken during the print, re-printing is carried out for the white-clarity row by using the normal heating element. After that, the heating elements being normal and consecutive are activated to continue the print under a condition that the recording paper 10 is advanced by an amount corresponding to a number of the consecutive heating elements. As to a case of the heating elements 34b to 34f of Nos. 2 to 6, a similar operation is performed.

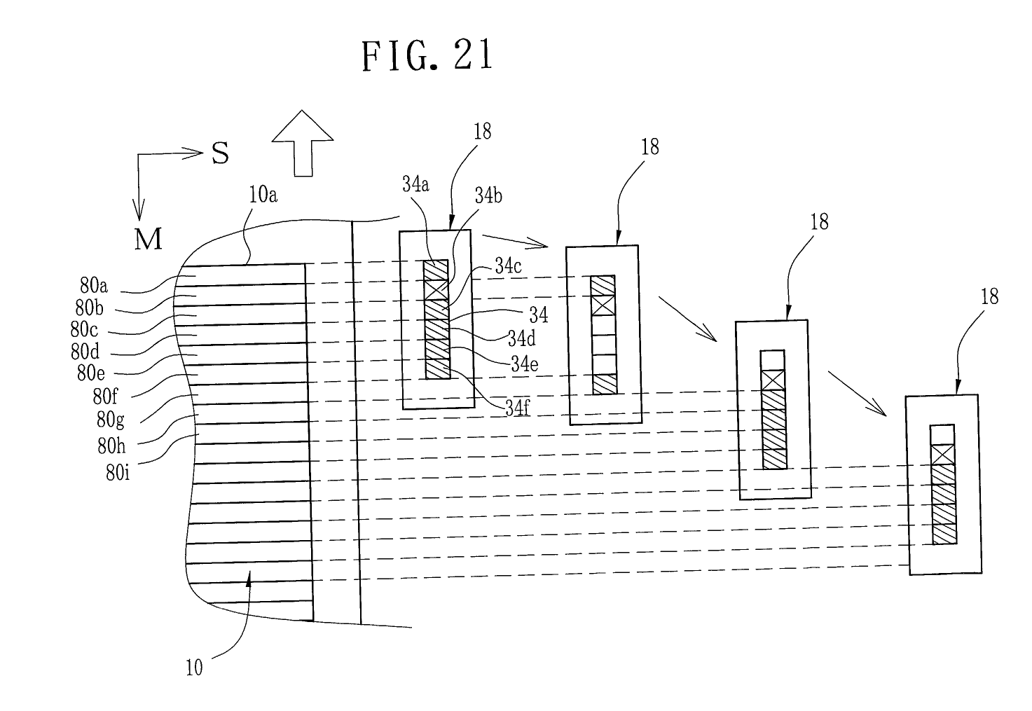

When the heating element 34b represented by No. 2 is the broken element such as shown in FIG. 21, the second row 80b to be recorded by this element 34b becomes the white-clarity row. In this case, the recording paper 10 is moved in the forward direction by one row. Then, the recording is performed for the white-clarity row 80b with the heating element 34a of No. 1, and at the same time, recording is performed for the seventh row 80g with the heating element 34f of No. 6. From the eighth row 80h, the heating elements 34a and 34b of by Nos. 1 and 2 are not activated, and the heating elements 34c to 34f of Nos. 3 to 6 are heated to repeat the movement of four rows and the recording thereof.

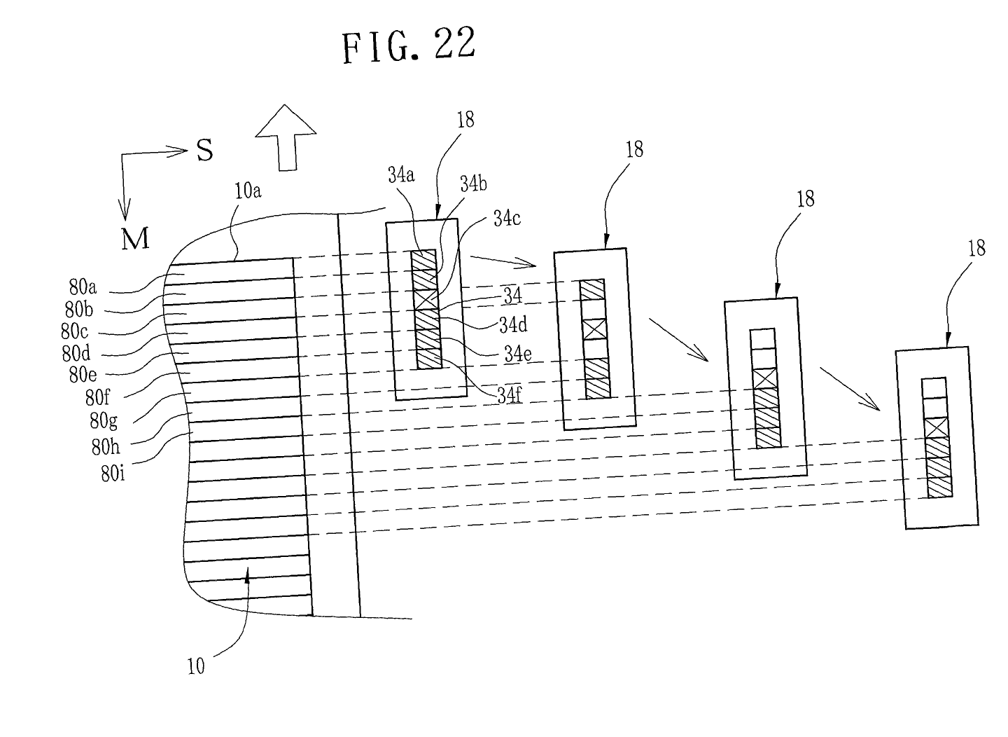

When the heating element 34c represented by No. 3 is the broken element such as shown in FIG. 22, the third row 80c becomes the white-clarity row. In this case, the recording paper 10 is moved in the forward direction by two rows, and the recording is performed for the white-clarity row 80c with the heating element 34a of No. 1. At the same time, recording is performed for the seventh row 80g and the eighth row 80h with the heating elements 34e and 34f of Nos. 5 and 6. From the ninth row 80i, the heating elements 34a to 34c of Nos. 1 to 3 are not activated, and the heating elements 34d to 34f of Nos. 4 to 6 are heated to repeat the movement of three rows and the recording thereof.

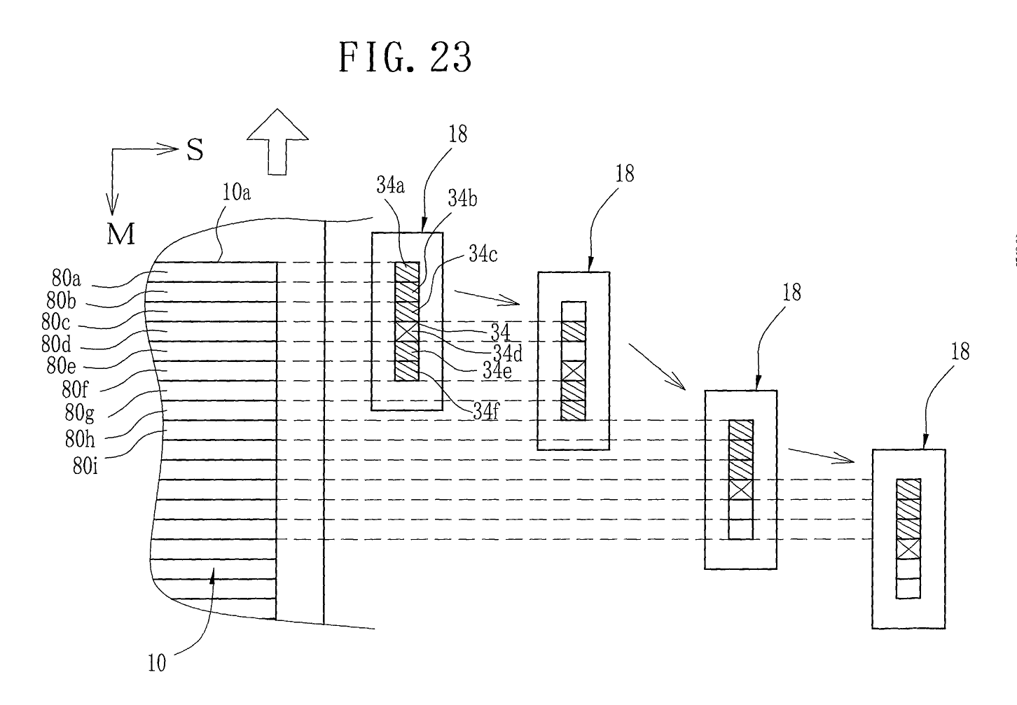

When the heating element 34d represented by No. 4 is the broken element such as shown in FIG. 23, the fourth row 80d becomes the white-clarity row. In this case, the recording paper 10 is moved in the forward direction by two rows, and the recording is performed for the white-clarity row 80d with the heating element 34b of No. 2. At the same time, recording is performed for the seventh row 80g and the eighth row 80h with the heating elements 34e and 34f of Nos. 5 and 6. From the ninth row 80i, the heating elements 34d to 34f of Nos. 4 to 6 are not activated, and the heating elements 34a to 34c of Nos. 1 to 3 are heated to repeat the movement of three rows and the recording thereof.

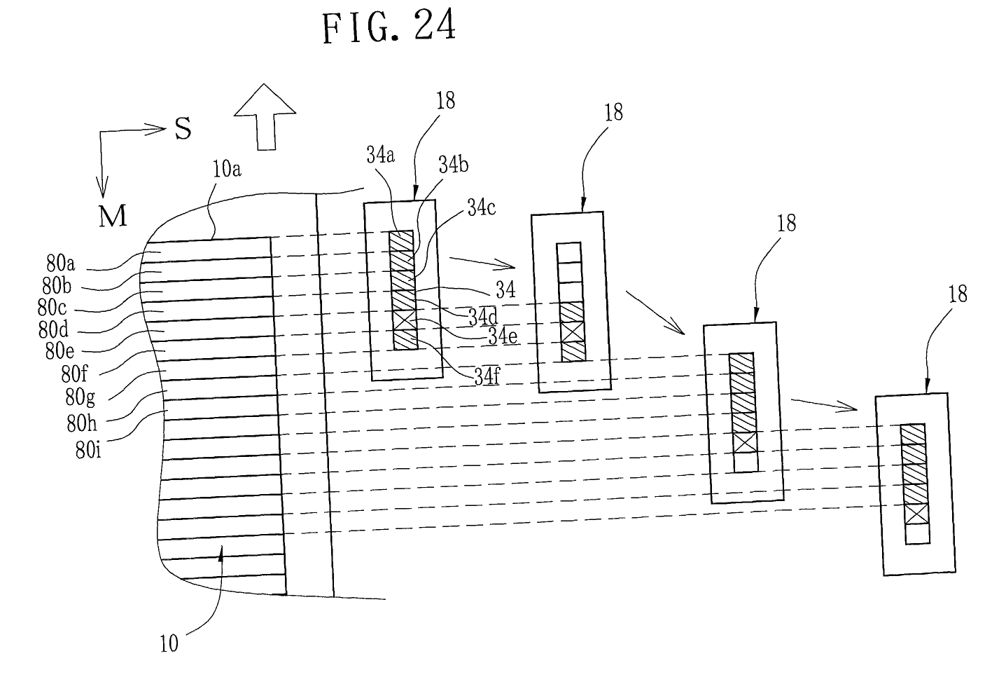

When the heating element 34e represented by No. 5 is the broken element such as shown in FIG. 24, the fifth row 80e becomes the white-clarity row. In this case, the recording paper 10 is moved in the forward direction by one row, and the recording is performed for the white-clarity row 80e with the heating element 34d of No. 4. At the same time, recording is performed for the seventh row 80g with the heating element 34f of No. 6. From the eighth row 80h, the heating elements 34e and 34f of Nos. 5 and 6 are not actuated, and the heating elements 34a to 34d of Nos. 1 to 4 are heated to repeat the movement of four rows and the recording thereof.

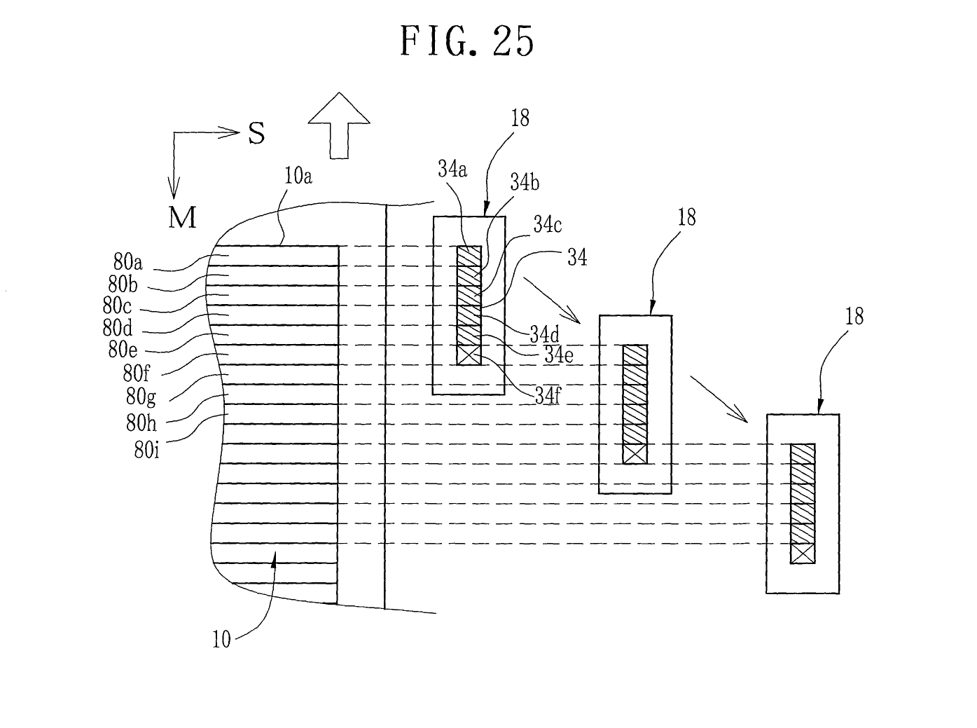

When the heating element 34f represented by No. 6 is the broken element such as shown in FIG. 25, the sixth row 80f becomes the white-clarity row. In this case, from the sixth row 80f, the heating element 34f of No. 6 are not actuated, and the heating elements 34a to 34e of Nos. 1 to 5 are heated to repeat the movement of five rows and the recording thereof.

In the third embodiment, the test-pattern area 10b is located at the lateral side of the image area 10a. Moreover, the test patterns 72, 73 and 74 are formed on the extended line of the six rows recorded on the image area 1a. This embodiment, however, is not exclusive to the above. Such as shown in FIG. 26, the test-pattern area 10b may be located at a downstream side of the image area 10a relative to the conveying direction thereof. In this case, after recording the test patterns 72g, 73g and 74g, the recording paper 10 is moved by an amount corresponding to the test-pattern area 10b. Then, the image area 10a is started to be recorded. It is possible to widen the image area 10a in the width direction of the recording paper 10 so that the recording paper 10 can be efficiently used. Further, in this case, an image is printed after the test print so that the white-clarity row does not occur. For instance, if the heating element 34a is the broken element, the image area 10a is printed by using the heating elements 34b to 34f under a condition that five rows are intermittently moved.

Although the heat-transfer serial printer is described in the third embodiment as an example, this embodiment is applicable to the thermal serial printer shown in FIG. 10, similarly to the first and second embodiments. Further, this embodiment is applicable to the ink-jet serial printer shown in FIG. 11. In the case of the ink-jet serial printer, failure is not detected relative to the heating elements, but is detected relative to the ink nozzles arranged in the main-scanning direction. Test patterns are recorded by the ink nozzles, and densities thereof are measured to judge the failure of the nozzle based on whether or not the measured density reaches a prescribed minimum density.

In the third embodiment, is described the case in that one of the heating elements is broken. The present invention is not exclusive to this and is applicable to a case in that several heating elements are broken, for example, a case in that two of the six heating elements are judged as the broken elements. In such case, similarly to the above embodiment, recording is performed for the white-clarity row with one of the remaining four heating elements. With respect to the following rows, a moving amount of the recording paper 10 is adjusted and recording is performed with the heating elements whose number is identical with a number of the rows corresponding to the moving amount.

The number of the rows recorded after repairing the white-clarity row corresponds to a maximum number of the consecutive recording elements being normal. When the outside recording element has broken, the number of the consecutive elements exists by only one. On the other hand, when the inside recording element has broken, two numbers of the consecutive elements exist. For instance, when the second recording element has broken, the numbers of the consecutive elements are “1” and “4”. Thus, the recording is performed with the four recording elements under a condition that the rows are moved four by four. When two recording elements have broken, the maximum number of the consecutive elements is three.

In the third embodiment, when any recording element is not broken, the recording and the paper advancement are repeated under a condition that the predetermined number of rows are recorded and the recording paper is advanced every amount corresponding thereto. By the way, unevenness of the paper advancing amount is likely to occur in the serial printer so that sometimes a streak-like gap is caused between the adjacent lines. This gap may be prevented from occurring by reducing the paper advancing amount, namely by overlapping the end rows of the adjacent lines. Such a method is described in Japanese Patent Laid-Open Publication No. 7-125288. In this case, recording of the overlapping rows is performed at fifty percent of the density obtained from the image data. In virtue of this, the overlapped row is recorded in full density after all.

In the method for overlapping the rows, when the recording element has broken, it is judged first whether the broken recording element is for recording the end row of the line or for recording the other rows. And then, a position of the row to be recorded with the broken element is adjusted to one of the other normal elements. When the broken element is for recording the end row of the line, recording is performed in fifty-percent density. When the broken element is for recording the other rows, recording is performed in full density. After that, recording is continued with the normal recording elements which are consecutively aligned. The paper advancing amount corresponds to a number of rows obtained by subtracting the overlapping rows from the consecutive normal elements. The overlapped row is recorded with the end element of the consecutive normal elements. Incidentally, the number of the overlapping row is not exclusive to one. A plurality of rows may be overlapped.

In the serial printing method and the serial printer using the same described in the first to third embodiments, the defective print of the blur, the white clarity, and so forth are corrected while the printing is performed. The present invention, however, is not exclusive to these embodiments. A fourth embodiment according to the present invention is described below. The fourth embodiment relates to a serial printing method and a serial printer using the same in which a printed recording paper having been discharged to the outside of the printer is set thereto again to perform correction recording relative to a defective print portion. A member being identical with that of the first to third embodiments is denoted by the same reference numeral, and detailed explanation thereof is omitted.

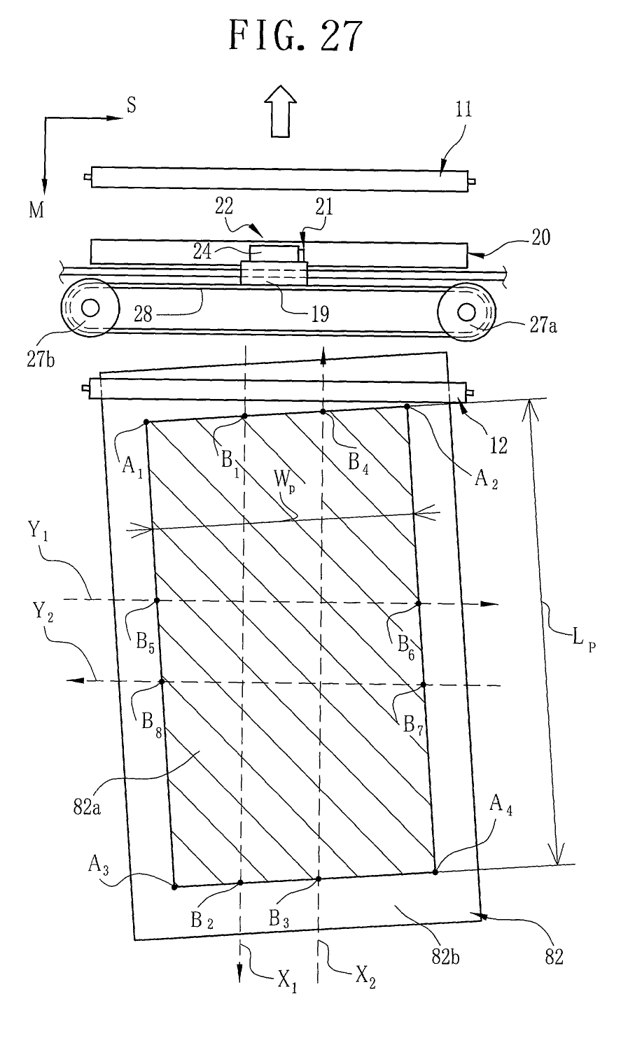

A heat-transfer serial printer used in this embodiment is identical with the printer shown in FIGS. 1 and 2, and this serial printer employs the ink ribbon 23 shown in FIG. 3. As the density sensor 21 attached to the carriage 19, the sensor shown in FIG. 4 is used. Although the density sensor 21 is used for measuring the density, this sensor 21 is also used for detecting an image area 82a of a recording paper 82 which is already printed and is set to the printer again such as shown in FIG. 27.

In FIG. 27, the image area 82a has a width Wp and a length Lp. Four corners of the image area 82a are respectively denoted by corner points A1, A2, A3 and A4 which are utilized for correcting a defective print portion. A moving range of the head unit 22 for reciprocating in the sub-scanning direction is adapted to be longer than the width Wp of the image area 82a. Owing to this, the defective print can be corrected regarding the whole of the image area 82a, even if the recording paper 82 is advanced in a slant state.

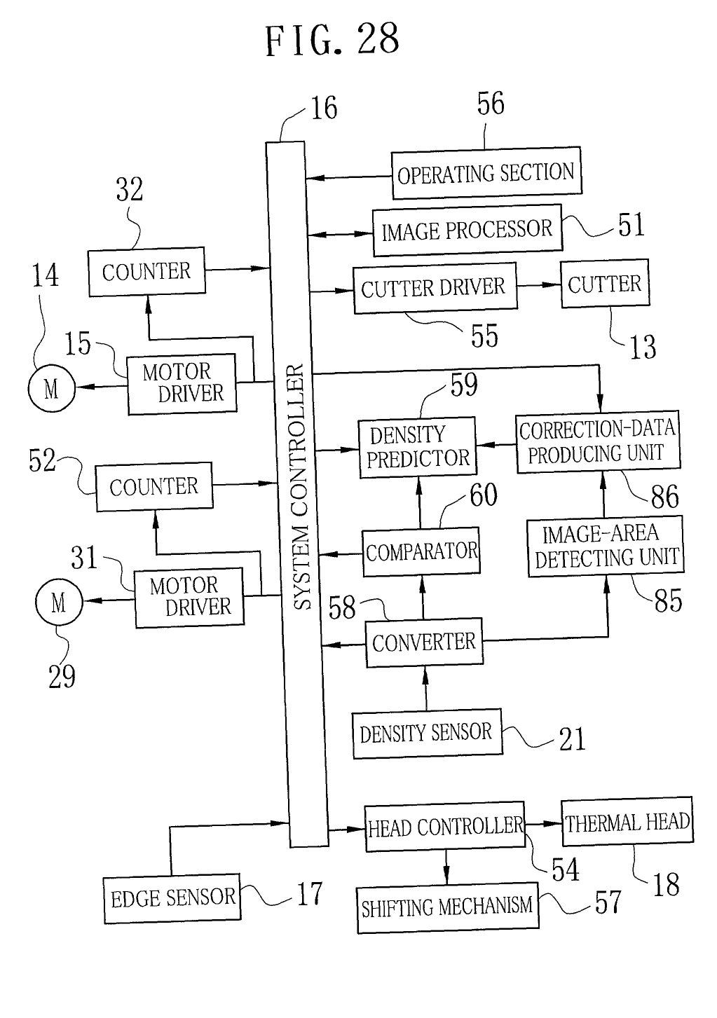

FIG. 28 schematically shows an electrical structure of the heat-transfer serial printer according to this embodiment. The system controller 16 is connected to an image-area detecting unit 85 and a correction-data making unit 86 in addition to the ones described in the above first embodiment. The density sensor 21 detects coordinates of reference points B1, B2, B3, B4, B5, B6, B7 and B8 positioned on a border line between the image area 82a and a margin portion 82b surrounding this area 82a. The detected coordinates are sent to the image-area detecting unit 85 in which coordinates of the corner points A1 to A4 are calculated from the coordinates of the reference points B1 to B8. The positional information of the image area 82a is sent to the correction-data making unit 86 in which positional information of the image data read from the image processor 51 is corrected based on the positional information of the image area 82a sent from the image-area detecting unit 85. In this way, the correction image data is made.

The correction image data made by the correction-data making unit 86 is sent to the density predictor 59. Based on the correction image data, the density predictor 59 obtains the density of each pixel of the image area as the predicted density.

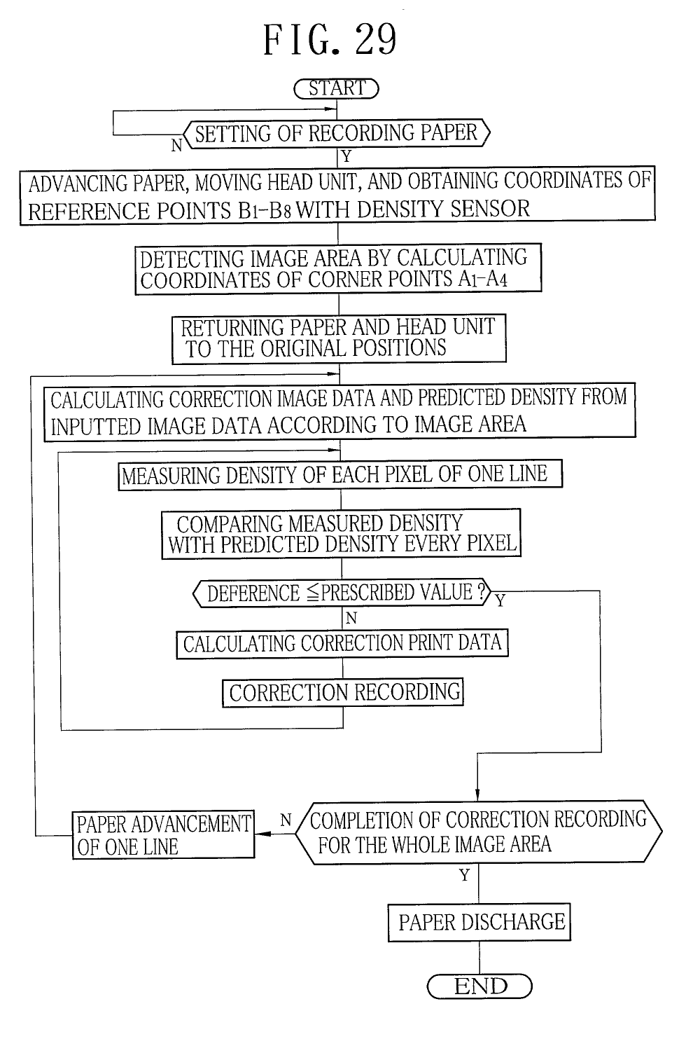

Hereinafter, an operation of the fourth embodiment is described, referring to a flow chart shown in FIG. 29. When the recording paper 82 already printed is set again to the serial printer 1 and the correction printing is instructed from the operating section 56, the recording paper 82 is advanced toward the head unit 22 to detect the coordinates of the reference points B1 to B8. When the reference points B1 to B8 are read out, the head unit 22 is moved first so as to adjust the density sensor 21 to a position of an arrow line X1. The arrow line X1 and an arrow line X2 are parallel to the main scanning direction M and an interval thereof is fixed. Further, the arrow lines X1 and X2 are located so as to approach a central portion of the width Wp of the image area 82a. While the recording paper 82 is advanced in the main-scanning direction, the density sensor 21 reads the density of the recording paper 82 along the arrow line X1. Based on whether or not the read density reaches a prescribed reference density, the density sensor 21 judges either the image area 82a or the margin portion 82b. In this way, the coordinates of the reference points B1 and B2 are detected in order as the points located on the border line between the image area 82a and the margin portion 82b. Successively, the density sensor 21 is adjusted to a position of the arrow line X2. While the recording paper 82 is reversed in the main-scanning direction, the coordinates of the reference points B3 and B4 are similarly detected.

After that, the recording paper 82 is moved so as to adjust the density sensor 21 to a position of an arrow line Y1. The arrow line Y1 and an arrow line Y2 are parallel to the sub-scanning direction and an interval thereof is fixed. The arrow lines Y1 and Y2 are located so as to approach a central portion of the length Lp of the image area 82a. While the head unit 22 is moved from the left side of the recording paper 82 to the right side thereof in the drawing, the density sensor 21 reads the density of the recording paper 82 along the arrow line Y1. In this way, the reference points B5 and B6 are detected. Successively, the density sensor 21 is adjusted to a position of the arrow line Y2. While the head unit 22 is moved from the right side of the recording paper 82 to the left side thereof in the drawing, the coordinates of the reference points B7 and B8 are similarly detected. The detected coordinates of the reference points B1 to B8 are sent to the image-area detecting unit 85.

The image-area detecting unit 85 calculates the coordinates of the four corner points A1 to A4 based on the coordinates of the reference points B1 to B8. Hereinafter, for the sake of convenience, the coordinates of the reference points B1 to B4 are represented by (B1x, B1y) to (B8x, B8y), and the coordinates of the corner points A1 to A4 are represented by (A1x, A1y) to (A4x, A4y). First, a method for calculating the coordinate (A1x, A1y) of the corner point Al is described below. A straight line passing the reference points B1 and B4 is expressed as follows:

Y=m1X+n1 (1)

wherein

ml =(B4y−B1y)/(B4x−B1x)

n1=B1y−((B4y−B1y)/(B4x−B1x)) B1x

Meanwhile, a straight line passing the reference points B5 and B8 is expressed as follows:

Y=m2X+n2 (2)

wherein

m2=(B8y−B5y)/(B8x−B5x)

n2=B5y−((B8y−B5y)/(B8x−B5x)) B5x

The corner point A1 is an intersection of the straight lines expressed by the above formulas (1) and (2) so that (X, Y)=(A1x, A1y) is assigned to the formulas (1) and (2).

A1y=m1 (A1x)+n1 (3)

A1y=m2 (A1x)+n2 (4)

Based on the above formulas (3) and (4), the coordinates (A1x, A1y) of the corner point A1 is obtained as follows:

A1x=(n2−n1)/(m1−m2)

A1y=m1 (n2−n1)/(m1−m2)+n1

wherein

m1=(B4y−B1y)/(B4x−B1x)

n1=B1y−((B4y−B1y)/(B4x−B1x)) B1x

m2=(B8y−B5y)/(B8x−B5x)

n2=B5y−((B8y−B5y)/ (B8x−B5x)) B5x

The coordinates (A2x, A2y) to (A4x, A4y) of the corner points A2 to A4 are similarly obtained from formulas of the straight lines respectively passing the reference points B1 and B4, the reference points B2 and B3, the reference points B5 and B8, and the reference points B6 and B7. By obtaining the coordinates (A1x, A1y) to (A4x, A4y) of the corner points A1 to A4 in this way, the image area 82a is recognized. Then, the positional information of the image area 82a is sent to the correction-data making unit 86. Meanwhile, the recording paper 82 and the head unit 22 are returned to the respective initial positions.

In the correction-data making unit 86, when the positional information of the image area 82a is sent from the image-area detecting unit 85, the correction image data is made such that positional information of the image data read from the image processor 51 is inclined and moved in accordance with inclination and positional difference relative to the normal image area used in the normal recording. Incidentally, the inclination and the positional difference relative to the normal image area concern both of the main-scanning direction and the sub-scanning direction. The correction image data is sent to the density predictor 59 to calculate the predicted density of each color every pixel. After calculating the predicted density, the recording paper 82 is advanced toward the head unit 22. Further, the density sensor 21 is activated and the head unit 22 is moved. In synchronism with this movement of the head unit 22, the measured density of the recording paper 82 is read. When the difference between the measured density and the predicted density is a prescribed value or less, the density is judged to be within a proper range.

When the measured density is smaller than the predicted density and the difference between them exceeds a predetermined value, the system controller 16 judges a lack of density. In this case, correction print data is made every pixel in accordance with an amount of the density lack. Then, the recording head 22 is moved in the backward direction. In synchronism with this movement, the thermal head 18 is driven based on the correction print data to perform correction recording in accordance with the amount of the density lack. When the density is proper or when the density lack has been corrected by the correction recording, the recording paper 82 is advanced to measure the density of the next line and to perform the correction recording. Similarly, the correction recording is performed for the whole of the image area 82a. In this way, the image blur and the uneven density formed on the recording paper 82 are corrected so that the clear image may be obtained.

In the fourth embodiment, the coordinates of eight reference points B1 to B8 are read to take the positional information of the image area 82a. Base on the coordinates of the reference points B1 to B8, the coordinates of four corner points A1 to A4 of the image area 82a are obtained. The present invention, however, is not exclusive to this. For instance, pre-scanning having rough resolution may be performed for the whole of the recording paper 82 before correction recording. In this case, based on the pre-scanning data for the whole area, the coordinates of the four corner points A1 to A4 are obtained.

Although the present invention has been fully described by way of the preferred embodiments thereof with reference to the accompanying drawings, various changes and modifications will be apparent to those having skill in this field.

Therefore, unless otherwise these changes and modifications depart from the scope of the present invention, they should be construed as included therein.

What is claimed is:

1. A serial printing method for recording an image on a recording material one line by one line, said line including one or more rows and said line being recorded by moving a recording head in a width direction of said recording material, said serial printing method comprising the steps of:
recording said row with said recording head;
detecting whether or not a print defect occurs on said recorded row; and
performing correction recording relative to said row on which said print defect occurs.

2. A serial printing method according to claim 1, wherein said line includes a plurality of said rows respectively recorded with recording elements of said recording head.

3. A serial printing method according to claim 2, wherein said print defect of said row is detected by measuring a density of each pixel constituting said row, and said correction recording is performed relative to said pixel on which a lack of density occurs.

4. A serial printing method according to claim 1, wherein said recording material is a thermosensitive recording paper including a thermosensitive coloring layer, and said recording head is a thermal head for recording said image by heating said thermosensitive coloring layer.

5. A serial printing method according to claim 1, wherein said recording head is a thermal head for heating an ink ribbon from its back side, said image being recorded by transferring one of thermally melted ink and thermally sublimated ink onto a surface of said recording material.

6. A serial printing method according to claim 1, wherein said recording head is an ink-jet recording head for recording said image by jetting ink to said recording material.

7. A serial printer including a carriage and a recording head held thereby, said carriage being reciprocated in a sub-scanning direction which is a width direction of a recording material, and said recording head recording a predetermined number of rows on said recording material in accordance with image data during the forward movement of said carriage, said serial printer comprising:
density measuring means attached to said carriage and for obtaining a measured density of a recorded portion when said carriage is moved backward;
density predicting means for obtaining a predicted density to be recorded on said portion, based on said image data;
operation means for comparing said measured density with said predicted density every portion, said operation means obtaining density difference when said measured density is less than said predicted density;
record correcting means for performing correction recording relative to the defective portion having said density difference, said record correcting means reciprocating said carriage again for the defective portion and driving said recording head in accordance with said density difference during the forward movement of said carriage; and
recording-material advancement means for advancing said recording material in a main-scanning direction perpendicular to said sub-scanning direction, in order to record the next predetermined number of the rows on said recording material.

8. A serial printer including a carriage and a recording head held thereby, said carriage being reciprocated in a sub-scanning direction which is a width direction of a recording material, and said recording head recording a predetermined number of rows on said recording material in accordance with image data during the reciprocation of said carriage, said serial printer comprising:
first density measuring means disposed on one side of said recording head in said sub-scanning direction, said first density measuring mean obtaining a measured density of a recorded portion just after recording when said carriage is moved forward;
second density measuring means disposed on the other side of said recording head in said sub-scanning direction, said second density measuring means obtaining a measured density of a recorded portion just after recording when said carriage is moved backward;
density predicting means for obtaining a predicted density to be recorded on said portion, based on said image data;
operation means for comparing said measured density with said predicted density every portion, said operation means obtaining density difference of the defective portion having said measured density which is less than said predicted density;
record correcting means for performing correction recording relative to said defective portion, said record correcting means reciprocating said carriage again for the defective portion and driving said recording head in accordance with said density difference during the movement of said carriage; and
recording-material advancement means for advancing said recording material in a main-scanning direction perpendicular to said sub-scanning direction, in order to record the next predetermined number of the rows on said recording material.

9. A serial printer according to claims 7 or 8, wherein said density measuring means includes a light emitting element for illuminating said recorded portion, and a light receiving element for converting the reflected light into an electric signal.

10. A serial printer according to claims 7 or 8, wherein said portion is a single pixel.

11. A serial printing method for recording an image on a recording material one line by one line, said line including a plurality of rows of which recording is performed by moving a recording head in a sub-scanning direction which is a width direction of said recording material, and said recording head having a plurality of recording elements arranged in a main-scanning direction perpendicular to said sub-scanning direction, said serial printing method comprising the steps of:
recording said rows with said recording head;
detecting the broken recording element among said recording elements, said broken recording element being impossible to record due to its failure; and
recording said row to be recorded with said broken recording element, by moving said recording head again and by using another normal recording element among said recording elements.

12. A serial printing method according to claim 11, wherein said broken recording element is detected by measuring a density of said row.

13. A serial printing method according to claim 11, wherein said broken recording element is detected by measuring a density of a test pattern recorded by said recording head.

14. A serial printing method according to claim 13, wherein said test pattern is arranged at a lateral side of said row in said sub-scanning direction.

15. A serial printing method according to claim 13, wherein said test pattern is arranged at a downstream side of said row in said main-scanning direction.

16. A serial printer including a carriage reciprocated in a sub-scanning direction which is a width direction of a recording material, a recording head held by said carriage, and moving means for moving said recording material in a main-scanning direction perpendicular to said sub-scanning direction, said recording head having M (M is an integer of two or more) recording elements arranged in said main-scanning direction to record said M rows on said recording material during the movement of said carriage, said serial printer comprising:
density measuring means attached to said carriage and for obtaining a measured density of said row recorded by said recording head;
failure judging means for judging the row as the defective row when said measured density is less than a prescribed value, said failure judging means judging the corresponding recording element as the broken recording element; and
control means for controlling drive of said recording element, reciprocation of said carriage, and movement of said recording material, when all of said recording elements are normal, said control means controlling the record under a condition that said recording element is moved every M rows, and when said failure detecting means detects said broken recording element, said control means controlling the record such that said recording material is moved by at least one row in said main-scanning direction to record with the normal recording element relative to said defective row, and successively the record being continued under a condition that said recording material is moved, in said main-scanning direction, in accordance with a number of the normal recording elements.

17. A serial printer according to claim 16, wherein when a number of the consecutive normal recording elements is N (N is an integer more than one and less than M), recording is performed with the consecutive normal recording elements, the number of which is N, in a condition that said recording material is moved in said main-scanning direction every N rows.

18. A serial printer according to claim 17, wherein said density measuring means includes a light emitting element for illuminating said recorded row, and a light receiving element for converting the reflected light into an electric signal.

19. A serial printer including a carriage reciprocated in a sub-scanning direction which is a width direction of a recording material, a recording head held by said carriage, and moving means for moving said recording material in a main-scanning direction perpendicular to said sub-scanning direction, said recording head having M (M is an integer of two or more) recording elements arranged in said main-scanning direction to record said M rows on said recording material during the movement of said carriage, said serial printer comprising:
density measuring means attached to said carriage and for obtaining a measured density of said row recorded by said recording head;
failure judging means for judging the row as the defective row when said measured density is less than a prescribed value, said failure judging means judging the corresponding recording element as the broken recording element; and
control means for controlling drive of said recording element, reciprocation of said carriage, and movement of said recording material, when all of said recording elements are normal, said control means controlling the record under a condition that said recording element is moved every (M−J) rows (J is an integer less than M) to overlap the J rows, and when said failure detecting means detects said broken recording element, said control means controlling the record such that said recording material is moved by at least one row in said main-scanning direction to record with the normal recording element relative to said defective row, and successively the record being continued under a condition that said recording material is moved, in said main-scanning direction, in accordance with a number of the normal recording elements.

20. A serial printer according to claim 19, wherein when a number of the consecutive normal recording elements is N (N is an integer more than one and less than M), recording is performed with the consecutive normal recording elements, the number of which is N, in a condition that said recording material is moved in said main-scanning direction every (N−K) rows (K is an integer less than N) to overlap the K rows.

21. A serial printer according to claim 20, wherein said density measuring means includes a light emitting element for illuminating said recorded row, and a light receiving element for converting the reflected light into an electric signal.

22. A serial printing method for recording an image on a recording material one line by one line, said line including one or more rows and said line being recorded by moving a recording head of a printer in a width direction of said recording material, said serial printing method comprising the steps of:
discharging said recording material on which said image has been recorded, from said printer;
setting said discharged recording material to said printer again;
detecting whether or not a print defect occurs on said recorded row; and
performing correction recording relative to said row on which said print defect occurs.

23. A serial printing method according to claim 22, wherein said print defect of said row is detected by measuring a density of said row.

24. A serial printer including a carriage reciprocated in a sub-scanning direction which is a width direction of a recording material, a recording head held by said carriage, and moving means for moving said recording material in a main-scanning direction perpendicular to said sub-scanning direction, said recording head recording a predetermined number of rows on said recording material in accordance with image data during the reciprocation of said carriage, said serial printer comprising:
image-area detecting means for obtaining positional information of an image area of said recording material already recorded;
data making means for making correction image data by calculating positional difference and inclination between said positional information of said image area and positional information of said image data, said data making means inclining and moving said image data in accordance with said positional difference and said inclination;
density predicting means for obtaining a predicted density to be recorded on each portion of said image area, based on said correction image data;
density measuring means attached to said carriage and for obtaining a measured density of said portion of said image area during the movement of said carriage;
operation means for comparing said measured density with said predicted density every portion, said operation means obtaining density difference of the defective portion having said measured density which is less than said predicted density; and
record correcting means for performing correction recording relative to said defective portion, said record correcting means moving said carriage again for the defective portion and driving said recording head in accordance with said density difference during the movement of said carriage.

25. A serial printer according to claim 24, wherein said image-area detecting means detects a border line between said image area and its surrounding portion by using said density measuring means to detect said image area, under a condition of moving said carriage and moving said recording material by said moving means.

26. A serial printer according to claim 25, wherein said density measuring means includes a light emitting element for illuminating said recorded portion, and a light receiving element for converting the reflected light into an electric signal.
